(19) United States
(12) Patent Application Publication
(10) Pub. No.: US 2009/0233176 A1
(43) Pub. Date: Sep. 17, 2009

(54) NON-AQUEOUS ELECTROLYTE SECONDARY BATTERY

(76) Inventors: Yosuke Kita, Osaka (JP); Yukishige Inaba, Hyogo (JP); Kunihiko Mineya, Osaka (JP); Takeshi Yao, Hyogo (JP)

Correspondence Address: MCDERMOTT WILL & EMERY LLP, 600 13TH STREET, NW, WASHINGTON, DC, 20005-3096, US

(21) Appl. No.: 12/089,498

(22) PCT Filed: Dec. 15, 2006
(86) PCT No.: PCT/JP2006/325081

§ 371 Date: Apr. 7, 2008

(30) Foreign Application Priority Data
Dec. 20, 2005 (JP) 2005-366064

(51) Int. Cl. H01M 4/58

(52) U.S. Cl. 429/231.95

(57) ABSTRACT

An object of the present invention is to provide a non-aqueous electrolyte secondary battery that is excellent in cycle characteristics even in a high-temperature environment and high in thermal stability. The non-aqueous electrolyte secondary battery of the present invention comprises at least one of an active material A and an active material C, and an active material B as positive electrode active materials. The active material A is LiₓCoO₂ (0.9≦x≦1.2). The active material B is LiₓNi_{y}Mn_{z}M_{1-y-z}O₂ (0.9≦x≦1.2, 0.1≦y≦0.5, 0.2≦z≦0.5, 0.2≦1−y−z≦0.5 and 0.9≦y/z≦2.5; and M is at least one selected from the group consisting of Co, Mg, Al, Ti, Sr, Ca, V, Fe, Y, Zr, Mo, Tc, Ru, Ta, W and Re). The active material C is LiₓCo₁₋ₐMₐO₂ (0.9≦x≦1.2 and 0.005≦a≦0.1; and M is at least one selected from the group consisting of Mg, Al, Ti, Sr, Mn, Ni, Ca, V, Fe, Y, Zr, Mo, Tc, Ru, Ta, W, Re, Yb, Cu, Zn and Ba).

### TECHNICAL FIELD

The present invention relates to a non-aqueous electrolyte secondary battery, mainly to an improvement of the positive electrode active material included in the non-aqueous electrolyte secondary battery.

### BACKGROUND ART

In recent years, downsizing, thinning, weight-lightening and highly functionalizing of portable electronic devices such as cellular phones and notebook-size personal computers have been rapidly developed. Along with such development, batteries used as power sources of portable electronic devices have been required to be downsized, thinned, weight-lightened and highly functionalized.

Currently, for the purpose of meeting the above-described requirements, non-aqueous electrolyte secondary batteries, in particular, lithium ion secondary batteries are used as power sources for portable electronic devices.

As a positive electrode active material for such non-aqueous electrolyte secondary batteries, lithium-containing transition metal oxides such as lithium cobaltate (LiCoO₂) and lithium nickelate (LiNiO₂) are used. Such lithium-containing transition metal oxides can attain high capacity densities, and exhibit satisfactory reversibility for absorption and desorption of lithium in high voltage regions.

However, non-aqueous electrolyte secondary batteries including the above-described positive electrode active materials are high in production cost because cobalt and nickel as the raw materials for the positive electrode active materials are high in price. Additionally, when a non-aqueous electrolyte secondary battery including any of the above-described positive electrode active materials is heated under the fully charged condition, the positive electrode active material and the non-aqueous electrolyte may be reacted with each other, and hence the battery generates heat.

On the other hand, spinel composite oxides such as lithium manganate (LiMn₂O₄) prepared by using manganese, as raw material, comparatively low in price have also been studied for use as a positive electrode active material. A non-aqueous electrolyte secondary battery using a spinel composite oxide as the positive electrode active material is characterized in that such a battery generates heat, when heated under the fully charged condition, less readily as compared to non-aqueous electrolyte secondary batteries using LiCoO₂, LiNiO₂ or the like as the positive electrode active material. However, such a non-aqueous electrolyte secondary battery is smaller in capacity density than the batteries using a cobalt material such as LiCoO₂ or a nickel material such as LiNiO₂.

For the purpose of solving such problems as described above, there have been proposed non-aqueous electrolyte secondary batteries each using, as the positive electrode active material, a mixture composed of two or more lithium-containing transition metal oxides (see Patent Documents 1 to 4).

In Patent Document 1, there has been proposed a non-aqueous electrolyte secondary battery using, as the positive electrode active material, a mixture composed of LiMn₂O₄, LiNiO₂ and LiCoO₂. However, such a positive electrode active material includes LiMn₂O₄ that is low in the discharge capacity per unit weight, and hence the discharge capacity of the positive electrode active material per unit weight is small.

Accordingly, there has been proposed the use, as the positive electrode active material, of lithium-containing transition metal oxides in which two or more transition metals such as cobalt, nickel and manganese are incorporated to form a solid solution. It is to be noted that such active materials are different in the electric properties such as the capacity, reversibility, thermal stability and operating voltage, depending on the types of the included transition metals.

For example, when LiNi_{0.8}Co_{0.2}O₂ prepared by incorporating nickel in place of part of the cobalt included in LiCoO₂ is used as a positive electrode active material, a higher capacity density of 180 to 200 mAh/g can be attained as compared to the capacity density of 140 to 160 mAh/g in the case where LiCoO₂ is used alone.

In Patent Document 2, for the purpose of improving the properties of LiNi_{0.8}Co_{0.2}O₂, there have been proposed composite oxides such as LiNi_{0.75}Co_{0.2}Mn_{0.05}O₂ further including Mn.

In Patent Document 3, there has been proposed a lithium-containing transition metal oxide represented by the following formula:

LiNiₓM₁₋ₓM_{y}O₂

where 0.30≦x≦0.65, 0≦y≦0.2, and M is a metal element selected from the group consisting of Fe, Co, Cr, Al, Ti, Ga, In and Sn.

In Patent Document 4, there has been proposed a mixture composed of a lithium-containing transition metal oxide represented by the following formula (a):

LiₓNi_{y}Mn_{1-y-z}M_{z}O₂

where x satisfies 0.9≦x≦1.2, y satisfies 0.40≦y≦0.60, z satisfies 0≦z≦0.2, and M is selected from the group consisting of Fe, Co, Cr and Al atoms,
and a lithium-cobalt composite oxide represented by the following formula (b):

LiₓCoO₂

where x satisfies 0.9≦x≦1.1.

From the viewpoint of the thermal stability and the like of the battery, for the separator in a non-aqueous electrolyte secondary battery, porous polyolefin film that is a thermoplastic resin film is frequently used. A separator made of a resin has a function (so-called shutdown function) such that when a trouble such as external short-circuiting is caused, the separator is softened due to the rapid temperature increase of the battery caused by the short-circuiting, the micropores (infinite number of small pores) in the separator are closed, the separator thus loses ion conductivity, and consequently the current stops. However, when the temperature of the battery continues to increase also after the shutdown, the separator is melted and thermally contracted, and hence the short-circuited area between the positive and negative electrodes is extended (so-called melt down).

Accordingly, there has been attempted the improvement of both of the shutdown property and the anti-meltdown property. However, the meltdown temperature of a separator made of polyolefin is decreased when the thermofusion property of the separator is enhanced for the purpose of improving the shutdown property of the separator. Thus, there is conceived an idea that there is used a composite separator composed of a porous polyolefin film and a heat-resistant resin film. For example, in Patent Document 5, there has been proposed a separator comprising a layer including a heat-resistant nitrogen-containing aromatic polymer (aramid or polyamideimide) and a ceramic powder and a porous polyolefin layer.

Patent Document 1: Japanese Laid-Open Patent Publication No. 11-003698

Patent Document 2: Japanese Laid-Open Patent Publication No. 10-027611

Patent Document 3: Japanese Laid-Open Patent Publication No. 2002-145623

Patent Document 4: Japanese Laid-Open Patent Publication No. 2002-100357

Patent Document 5: Japanese Laid-Open Patent Publication No. 2000-30686

### DISCLOSURE OF INVENTION

### Problem to be Solved by the Invention

In the techniques disclosed in Patent Documents 1 to 4, there has been obtained no positive electrode active material that is satisfactory in all the properties of the charge/discharge capacity, the cycle characteristics, the reliability in high-temperature storage and the thermal stability. In particular, by an experiment carried out by the present inventors, it has been revealed that the cycle characteristics at such high temperatures as assumed for the use in a high-temperature environment encountered in notebook-size personal computers or the like cannot be improved for some types of transition metals included in the positive electrode active material. The reason for this is conceivable as follows. When charge and discharge (hereinafter referred to as charge/discharge) is repeated at high temperatures, the positive electrode active material and the non-aqueous electrolyte are reacted with each other, and accordingly part of the transition metals (Co, Ni, Mn) in the positive electrode active material is dissolved in the non-aqueous electrolyte. Consequently, the degradation of the positive electrode active material is caused, and conceivably the cycle characteristics are thereby degraded.

By using the separator disclosed in Patent Document 5, made of a heat-resistant resin, the thermal stability of the battery can be enhanced. However, when the separator includes a heat-resistant resin, the cycle characteristics at high temperatures are degraded. This may be interpreted as follows. The heat-resistant resin included in the separator contains, for example, aramid or polyamideimide. Aramid is obtained by polymerizing an organic matter having amine groups (for example, paraphenylenediamine) and an organic matter having chlorine atoms (for example, terephthalic acid chloride). Accordingly, aramid contains chlorine atoms as terminal groups. Polyamideimide is obtained by reacting trimellitic anhydride monochloride with a diamine. Accordingly, similarly to aramid, polyamideimide also contains chlorine atoms as terminal groups. The residual chlorine atoms are isolated in the non-aqueous electrolyte by repeating charge/discharge, in a high-temperature environment, of the battery including the separator. When the thus isolated chlorine is present in the vicinity of the positive electrode active material comprising a lithium-containing transition metal oxide, a complex formation reaction occurs between part of the dissolved transition metals and the chlorine, and hence the elution amount of the transition metals is increased. Consequently, the portion, of the positive electrode active material, capable of contributing to the charge/discharge reaction is decreased. Thus, it is conceivable that when charge/discharge is repeated, the capacity is remarkably degraded.

Accordingly, an object of the present invention is to provide a non-aqueous electrolyte secondary battery that is excellent in cycle characteristics even in a high-temperature environment and high in thermal stability.

### Means for Solving the Problem

The non-aqueous electrolyte secondary battery of the present invention comprises a positive electrode comprising a positive electrode active material layer including a positive electrode active material, a negative electrode comprising a negative electrode active material layer including a negative electrode active material capable of absorbing and desorbing lithium, a non-aqueous electrolyte and a separator. The positive electrode active material comprises at least one selected from the group consisting of an active material A and an active material C, and an active material B. The active material A is a first lithium composite oxide represented by the formula (1):

LiₓCoO₂ (1)

where 0.9≦x≦1.2. The active material B is a second lithium composite oxide represented by the formula (2):

LiₓNi_{y}Mn_{z}M_{1-y-z}O₂ (2)

where 0.9≦x≦1.2, 0.1≦y≦0.5, 0.2≦z≦0.5, 0.2≦1−y−z≦0.5 and 0.9≦y/z≦2.5; and M is at least one selected from the group consisting of Co, Mg, Al, Ti, Sr, Ca, V, Fe, Y, Zr, Mo, Tc, Ru, Ta, W and Re. The active material C is a third lithium composite oxide represented by the formula (3):

LiₓCo₁₋ₐMₐO₂ (3)

where 0.9≦x≦1.2 and 0.005≦a≦0.1; and M is at least one selected from the group consisting of Mg, Al, Ti, Sr, Mn, Ni, Ca, V, Fe, Y, Zr, Mo, Tc, Ru, Ta, W, Re, Yb, Cu, Zn and Ba.

The separator preferably comprises a porous film including a heat-resistant resin, and the heat-resistant resin preferably contains chlorine atoms.

In an embodiment of the present invention, the separator preferably further comprises a porous film including polyolefin.

In another embodiment of the present invention, the porous film including the heat-resistant resin preferably includes a filler.

The heat-resistant resin more preferably contains at least one selected from the group consisting of aramid and polyamideimide.

The active material B accounts for preferably 10 to 90% by weight, more preferably 10 to 50% by weight of the positive electrode active material.

The element M contained in the active material B is preferably Co.

In the active material B, the molar ratio “y” of Ni and the molar ratio “z” of Mn to the total amount of Ni, Mn and element M are both preferably 1/3.

The density of the positive electrode active material in the positive electrode active material layer is preferably 3.3 to 3.7 g/cm³.

The mean particle size of the active material A or the active material C is preferably 3 to 12 μm, and the mean particle size of the active material B is preferably 3 to 12 μm.

The specific surface area of the positive electrode active material is preferably 0.4 to 1.2 m²/g. Additionally, the tap density of the positive electrode active material is preferably 1.9 to 2.9 g/cm³.

### EFFECT OF THE INVENTION

In the present invention, as described above, the positive electrode active material comprises at least one selected from the group consisting of the active material A and the active material C both high in conductivity and high in the average voltage during discharging, and the active material B excellent in thermal stability. Consequently, there can be provided a high-capacity non-aqueous electrolyte secondary battery that suppresses the capacity degradation of the battery even when charge/discharge is carried out at high temperatures, and excellent in cycle characteristics at high temperatures and thermal stability.

### BRIEF DESCRIPTION OF THE DRAWINGS

FIG. 1 is an oblique perspective view of a non-aqueous electrolyte secondary battery produced in an example;

FIG. 2 is a schematic vertical sectional view of the battery of FIG. 1 along the line A-A; and

FIG. 3 is a schematic vertical sectional view of the battery of FIG. 1 along the line B-B.

### BEST MODE FOR CARRYING OUT THE INVENTION

The non-aqueous electrolyte secondary battery of the present invention comprises a positive electrode, a negative electrode, a non-aqueous electrolyte and a separator. The positive electrode comprises a positive electrode active material layer including a positive electrode active material capable of absorbing and desorbing lithium. The negative electrode comprises a negative electrode active material layer including a negative electrode active material capable of absorbing and desorbing lithium.

The positive electrode active material comprises at least one selected from the group consisting of an active material A and an active material C, and an active material B.

The active material A is a first lithium composite oxide represented by the formula (1):

LiₓCoO₂ (1)

where 0.9≦x≦1.2.

The active material B is a second lithium composite oxide represented by the formula (2):

LiₓNi_{y}Mn_{z}M_{1-y-z}O₂ (2)

where 0.9≦x≦1.2, 0.1≦y≦0.5, 0.2≦z≦0.5, 0.2≦1−y−z≦0.5 and 0.9≦y/z≦2.5; and M is at least one selected from the group consisting of Co, Mg, Al, Ti, Sr, Ca, V, Fe, Y, Zr, Mo, Tc, Ru, Ta, W and Re.

The active material C is a third lithium composite oxide represented by the formula (3):

LiₓCo₁₋ₐMₐO₂ (3)

where 0.9≦x≦1.2 and 0.005≦a≦0.1; and M is at least one selected from the group consisting of Mg, Al, Ti, Sr, Mn, Ni, Ca, V, Fe, Y, Zr, Mo, Tc, Ru, Ta, W, Re, Yb, Cu, Zn and Ba.

It is to be noted that in each of the active materials A to C, the molar ratio “x” of lithium is the value immediately after the synthesis of the active material.

The above-described active materials A and C are high in conductivity but not very high in thermal stability. Further, when charge/discharge is repeated in a high-temperature environment, the transition metals contained in these active materials are dissolved into the non-aqueous electrolyte, and hence the degradation of the cycle characteristics tends to occur.

On the other hand, the active material B contains Ni, Mn and the element M in appropriate molar ratios, and hence even when charge/discharge is repeated at high temperatures, the crystal structure of the active material B is stably maintained. In other words, the active material B has a high thermal stability. However, the active material B is low in conductivity.

In the present invention, the positive electrode active material comprises at least one selected from the group consisting of the active material A and the active material C, and the active material B, and hence the active material A and/or the active material C and the active material B can compensate the shortcomings each other. In other words, since the active material B is high in thermal stability, even when the non-aqueous electrolyte secondary battery of the present invention is repeatedly charged/discharged, in a high-temperature environment at approximately 45° C., the elution of the metal elements contained in the active material B into the non-aqueous electrolyte is suppressed. Accordingly, the degradation of the positive electrode active material in a high-temperature environment can be suppressed. Further, the positive electrode active material comprises at least one of the active material A and the active material C both higher in conductivity than the active material B. Consequently, even when charge/discharge is repeated in a high-temperature environment, conducting paths can be ensured in the positive electrode active material layer. Accordingly, the degradation of the cycle characteristics in a high-temperature environment can be suppressed.

Thus, when the positive electrode active material comprises at least one selected from the group consisting of the active material A and the active material C both high in conductivity, and the active material B high in thermal stability, there can be obtained a non-aqueous electrolyte secondary battery excellent in high-temperature cycle characteristics and high in thermal stability.

Further, the active material A and the active material C are high in the average voltage during discharging. Accordingly, when the positive electrode active material comprises at least one selected from the group consisting of the active material A and the active material C, the charge/discharge capacity of the battery can also be improved.

In the active material B, the molar ratio “y” of Ni to the total amount of Ni, Mn and the element M is 0.1 to 0.5, preferably 0.25 to 0.5 and more preferably 0.3 to 0.5. When the molar ratio “y” is smaller than 0.1, the initial charge/discharge capacity is degraded. When the molar ratio “y” is larger than 0.5, the thermal stability of the battery is degraded.

The molar ratio z of Mn to the total amount of Ni, Mn and the element M is 0.2 to 0.5 and preferably 0.2 to 0.4. When the molar ratio “z” is smaller than 0.2, the thermal stability of the battery is degraded. When the molar ratio “z” is larger than 0.5, the initial charge/discharge capacity is degraded.

The molar ratio 1−y−z of the element M to the total amount of Ni, Mn and the element M is 0.2 to 0.5, preferably 0.21 to 0.5 and more preferably 0.21 to 0.4. When the molar ratio 1−y−z is smaller than 0.2, the thermal stability of the battery is degraded. When the molar ratio 1−y−z is larger than 0.5, the high-temperature cycle characteristics are degraded.

The ratio y/z is 0.9 to 2.5 and preferably 0.9 to 2.0. When the ratio y/z is smaller than 0.9, the initial charge/discharge capacity is degraded and the high-temperature cycle characteristics are also degraded. When the ratio y/z is larger than 2.5, the thermal stability of the battery is degraded.

In the active material C, the molar ratio “a” of the element M to the total amount of Co and the element M is 0.005 to 0.1, and preferably 0.01 to 0.05. When the molar ratio “a” is smaller than 0.005, it becomes difficult to attain the improvement effect of the high-temperature cycle characteristics due to the addition of the element M. When the molar ratio “a” is larger than 0.1, the initial charge/discharge characteristics are degraded.

The amount of the active material B is preferably 10 to 90% by weight and more preferably 10 to 50% by weight of the amount of the positive electrode active material. Adoption of such a range as described above for the amount of the active material B enables to obtain a non-aqueous electrolyte secondary battery having a satisfactory balance among the charge/discharge capacity, the cycle characteristics at high temperatures and the thermal stability. When the amount of the active material B is less than 10% by weight of the amount of the positive electrode active material, the repetition of the charge/discharge cycle in a high-temperature environment increases the elution amounts of the transition metal elements contained in the active materials A and C. Consequently, the high-temperature cycle characteristics are degraded. When the amount of the active material B is larger than 90% by weight of the amount of the positive electrode active material, the current collecting performance of the positive electrode active material is degraded, and hence the high-temperature cycle characteristics are degraded.

The element M contained in the active material B is preferably at least one selected from the group consisting of Co, Mg and Al, and is more preferably Co. When the active material B contains the above-described element, there can be obtained a non-aqueous electrolyte secondary battery excellent in the balance among the charge/discharge capacity, the cycle characteristics at high temperatures and the thermal stability.

Additionally, in the active material B, the molar ratio “y” of nickel and the molar ratio “z” of manganese to the total amount of Ni, Mn and the element M are both preferably 1/3. The molar ratios “y” and “z” both set at 1/3 enable to more stabilize the crystal structure of the active material B. Consequently, there can be obtained a non-aqueous electrolyte secondary battery excellent in thermal stability and cycle characteristics at high temperatures.

The density of the positive electrode active material in the active material layer is preferably 3.3 to 3.7 g/cm³. Adoption of such density as described above enables to readily produce a non-aqueous electrolyte secondary battery high in charge/discharge capacity and excellent in cycle characteristics. For example, in the case where the positive electrode is prepared by coating a current collector with a paste including the positive electrode active material, and by drying and rolling the thus treated current collector, when the density of the positive electrode active material in the obtained active material layer is larger than 3.7 g/cm³, a large load is exerted on the current collector at the time of rolling. Consequently, the current collector may be broken and hence the positive electrode cannot be prepared. Alternatively, even when the preparation of the positive electrode is successful, the secondary particles of the positive electrode active material may be disintegrated at the time of rolling, and hence the cycle characteristics are degraded.

When the density of the positive electrode active material in the active material layer is smaller than 3.3 g/cm³, the contact area between the positive electrode active material and the non-aqueous electrolyte becomes larger as compared to the case where the density of the positive electrode active material is 3.3 g/cm³ or more. Accordingly, when the charge/discharge of the non-aqueous electrolyte secondary battery is repeated in a high-temperature environment, there is a possibility that the reaction between the positive electrode active material and the non-aqueous electrolyte is promoted and the positive electrode active material may be degraded. Consequently, the cycle characteristics are degraded.

Additionally, when the positive electrode active material layer includes, in addition to the positive electrode active material, a binder, a conductive agent and the like, the mixing proportions of these are known, and hence the density of the positive electrode active material in the active material layer can be calculated from the volume and the weight of the active material layer.

The mean particle size of the active material A or the active material C included in the positive electrode active material is preferably 3 to 12 μm. Adoption of such a range as described above for the mean particle size of the active material A or the active material C enables to obtain a non-aqueous electrolyte secondary battery excellent in charge/discharge capacity, high-temperature cycle characteristics and thermal stability.

In the case where the mean particle size of the active material A or the active material C included in the positive electrode active material is smaller than 3 μm, when the non-aqueous electrolyte secondary battery is charged/discharged at high temperatures, the reactivity of the active material A or the active material C is enhanced, consequently the positive electrode active material and the non-aqueous electrolyte may react with each other, and the positive electrode active material is thereby degraded. Consequently, the cycle characteristics may be degraded.

When the mean particle size of the active material A or the active material C is larger than 12 μm, the specific surface area of the active material A or the active material C is small, and hence the reaction area, of the active material A or C, capable of contributing to the charge/discharge is also decreased. Additionally, the reaction between the active material and the non-aqueous electrolyte further decreases the reaction area capable of contributing to the charge/discharge. Consequently, the intercalation and deintercalation reaction of the lithium ions in the non-aqueous electrolyte with the positive electrode active material may be concentrated in specified portions of the positive electrode active material particles, and hence the positive electrode active material is rapidly degraded. Accordingly, the cycle characteristics of the battery may be degraded.

The mean particle size of the active material B included in the positive electrode active material is preferably 3 to 12 μm. Adoption of such a range as described above for the mean particle size of the active material B enables to obtain a non-aqueous electrolyte secondary battery excellent in charge/discharge capacity, high-temperature cycle characteristics and thermal stability.

In the case where the mean particle size of the active material B is smaller than 3 μm, when the battery is charged/discharged at high temperatures, the reactivity of the active material B may be enhanced, and hence the positive electrode active material and the non-aqueous electrolyte react with each other and hence the active material B is degraded. Consequently, the cycle characteristics may be degraded. When the mean particle size of the active material B is larger than 12 μm, the reaction area, of the active material B, capable of contributing to the charge/discharge may be decreased in a manner similar to that described above. Consequently, the positive electrode may be rapidly degraded, and hence the cycle characteristics are degraded.

It is to be noted that the mean particle size of each of the active materials A, B and C is a value corresponding to an accumulated weight of 50% in a measurement with a laser diffraction particle size analyzer.

The specific surface area of the positive electrode active material is preferably 0.4 to 1.2 m²/g. Adoption of such a range as described above for the specific surface area of the positive electrode active material enables to obtain a non-aqueous electrolyte secondary battery excellent in charge/discharge capacity, high-temperature cycle characteristics and thermal stability.

In the case where the specific surface area of the positive electrode active material is larger than 1.2 m²/g, when the battery is intentionally heated to a temperature as high as 150° C., the reactivity of the positive electrode active material is enhanced and hence the thermal stability of the battery is degraded. Additionally, when the battery is charged/discharged at high temperatures, gas generation is large and the positive electrode active material is rapidly degraded. Consequently, the cycle characteristics may be degraded.

When the specific surface area of the positive electrode active material is smaller than 0.4 m²/g, the reaction area, of the positive electrode active material, capable of contributing to charge/discharge is decreased. Consequently, the positive electrode active material may be rapidly degraded, and hence the cycle characteristics of the battery are degraded.

It is to be noted that when the specific surface area of the positive electrode active material is 0.4 to 1.2 m²/g, the specific surface area of each of the active material A, the active material B and the active material C may either be 0.4 to 1.2 m²/g or fall outside the above-described range.

The specific surface area of the positive electrode active material can be measured, for example, by means of a method for measuring the specific surface area (JIS R 1626) based on the gas adsorption BET method for fine ceramic powders.

The tap density of the positive electrode active material is preferably 1.9 to 2.9 g/cm³. Adoption of such a range as described above for the tap density of the positive electrode active material enables to obtain a non-aqueous electrolyte secondary battery excellent in charge/discharge capacity, high-temperature cycle characteristics and productivity.

In the case where the tap density of the positive electrode active material is smaller than 1.9 g/cm³, when the positive electrode active material is rolled so as to obtain a predetermined density, for example, with a press, a large pressure is required. Consequently, the productivity is remarkably degraded. Additionally, a large load is exerted on the positive electrode active material layer at the time of rolling, and hence the secondary particles of the positive electrode active material are disintegrated into the primary particles. Consequently, when the battery is charged/discharged at high temperatures, gas generation is large and the positive electrode is rapidly degraded. Consequently, the high-temperature cycle characteristics may be degraded.

In the case where the tap density of the positive electrode active material is larger than 2.9 g/cm³, the particle size of the positive electrode active material becomes large. Accordingly, the reaction area of the positive electrode plate is decreased as compared to the case where the tap density is smaller than 2.9 g/cm³. Consequently, in the positive electrode and the negative electrode, the intercalation and deintercalation reaction of lithium ions is concentrated locally. Consequently, when the charge/discharge cycle is repeated, those lithium ions which should be intercalated into the negative electrode active material are not intercalated into the negative electrode active material, and lithium metal is precipitated on the negative electrode. Consequently, the cycle characteristics may be degraded.

The tap density can be measured, for example, as follows.

In a graduated cylinder having a weight of D (g), 50 g of the positive electrode active material is placed. Then, the operation in which the positive electrode active material-containing graduated cylinder is vertically dropped from the height of 20 mm is repeated with an interval of 2 seconds for 1 hour. The total weight E (g) of the graduated cylinder and the volume F(cm³) of the positive electrode active material are measured. By using these values and the following formula, the tap density of the positive electrode active material can be obtained:

Tap density (g/cm³)=(E−D)/F

LiₓCoO₂ as the active material A can be obtained by mixing, for example, a lithium compound and a cobalt compound in a predetermined ratio, and by baking the obtained mixture at 600 to 1100° C.

LiₓNi_{y}Mn_{z}M_{1-y-z}O₂ as the active material B can be prepared, for example, as follows.

A lithium compound, a manganese compound, a nickel compound and an M-containing compound are mixed together in a predetermined ratio. By baking the obtained mixture in an inert gas atmosphere or in the air at 500 to 1000° C. by means of a solid phase method, the active material B can be obtained. Alternatively, by baking the mixture at 500 to 850° C. by means of a molten salt method, the active material B can be obtained.

LiₓCo₁₋ₐMₐO₂ as the active material C can be obtained, for example, by mixing a lithium compound, a cobalt compound and an M-containing compound in a predetermined ratio, and by baking the obtained mixture at 600 to 1100° C.

As the lithium compound, for example, lithium carbonate, lithium hydroxide, lithium nitrate, lithium sulfate and lithium oxide can be used.

As the cobalt compound, for example, cobalt oxide and cobalt hydroxide can be used.

As the nickel compound, for example, oxides (NiO and the like), hydroxide (NiOH) and oxyhydroxide (NiOOH) can be used.

As the manganese compound, compounds containing trivalent manganese are preferably used. Such manganese compounds may be used each alone or in combinations of two or more thereof.

As the M-containing compound, for example, an M-containing oxide, an M-containing hydroxide, an M-containing sulfate and an M-containing nitrate can be used.

Next, the separator is described.

The separator comprises a porous film. The porous film may be, for example, either an inorganic microporous film or an organic microporous film. The separator may comprise both of an inorganic microporous film and an organic microporous film.

The inorganic microporous film includes, for example, an inorganic filler and a binder for bonding the inorganic filler. Examples of the inorganic filler include alumina and silica. The binder included in the inorganic microporous film is not particularly limited. Examples of the binder include polyvinylidene fluoride (PVDF), polytetrafluoroethylene (PTFE), and a modified acrylonitrile-polyacrylic acid rubber particle (for example, BM-500B manufactured by ZEON Corporation, Japan). It is to be noted that PTFE and BM-500B are preferably used in combination with a thickener. Examples of the thickener include carboxymethyl cellulose, polyethylene oxide and a modified acrylonitrile rubber (for example, BM-720H, manufactured by ZEON Corporation, Japan); however, the thickener is not limited to these examples.

The amount of the binder is preferably 1 to 10 parts by weight and more preferably 2 to 8 parts by weight per 100 parts by weight of the inorganic filler, from the viewpoint of maintaining the mechanical strength of the inorganic microporous film and ensuring the ion conductivity. Most of the binders are characterized by being swollen by the non-aqueous solvent included in the non-aqueous electrolyte. Accordingly, when the amount of the binder exceeds 10 parts by weight, the voids in the inorganic microporous film are filled due to the excessive swelling of the binder. Consequently, the ion conductivity of the inorganic microporous film is degraded, and the battery reaction may be inhibited. When the amount of the binder is less than 1 part by weight, the mechanical strength of the inorganic microporous film may be degraded.

When an inorganic microporous film is used as the separator, the inorganic microporous film has only to be interposed between the positive electrode and the negative electrode. In this case, the inorganic microporous film may be disposed only on the surface of the positive electrode or the negative electrode, or may be disposed on the surfaces of both of the positive electrode and the negative electrode. When an inorganic microporous film is used as the separator, the thickness of the inorganic microporous film is preferably 1 to 20 μm.

When the separator comprises both of an inorganic microporous film and an organic microporous film, the thickness of the inorganic microporous film is preferably 1 to 10 μm.

As an organic microporous film, for example, porous sheets or non-woven fabric produced by using as raw materials polyolefins such as polyethylene and polypropylene can be used. A porous film including a heat-resistant resin can also be used as the organic microporous film. The thickness of the organic microporous film is preferably 10 to 40 μm.

The porous film including a heat-resistant resin preferably includes a heat-resistant resin containing chlorine atoms. In this case, the positive electrode active material preferably comprises at least one lithium-containing composite oxide containing Al in the composition thereof.

When at the time of high-temperature cycle, the chlorine atoms remaining as the terminal groups in the heat-resistant resin constituting the separator are isolated into the non-aqueous electrolyte, the isolated chlorine atoms form complexes preferentially with Al. Consequently, the elution of the other transition metal elements, constituting the positive electrode active material, from the positive electrode active material can be suppressed. This is ascribable to the fact that Al is higher in the stability constant in the complex formation with chlorine as compared to the transition metals such as Co, Ni and Mn, and hence Al and chlorine tend to preferentially form a complex.

As described above, when the separator includes a heat-resistant resin containing chlorine atoms, by making the positive electrode active material contain Al as a constituent element thereof, the elution of the main constituent elements (such as Co, Ni, Mn) of the positive electrode active material into the non-aqueous electrolyte can be suppressed. Consequently, there can be obtained a non-aqueous electrolyte secondary battery excellent in the balance between the high-temperature cycle characteristics and the thermal stability.

The heat-resistant resin containing chlorine atoms preferably includes at least one selected from the group consisting of aramid and polyamideimide. These heat-resistant resins are soluble in polar organic solvents, and hence are excellent in film formation performance and are easily formed into porous films. Additionally, the porous film including the above-described heat-resistant resin is extremely high in capability of retaining the non-aqueous electrolyte and in heat resistance.

When the separator includes a heat-resistant resin containing chlorine atoms, the amount of the chlorine atoms contained in the separator is preferably 50 to 2000 μg per 1 g of the separator because such heat-resistant resin that contains chlorine atoms in an amount falling within the above-described range can be easily produced.

The organic microporous film is preferably a laminated film comprising a porous film made of polyolefin and a porous film including a heat-resistant resin. Use of such a laminated film enables to obtain a non-aqueous electrolyte secondary battery excellent in heat resistance while ensuring the electronic conductivity imparted to the porous film made of polyolefin. Also in this case, the thickness of the organic microporous film is preferably 10 to 40 μm.

In the above-described laminated film, the porous film including a heat-resistant resin may be disposed on the porous film made of polyolefin, or the reverse of this may also be adopted.

In the above-described laminated film, the porous film including a heat-resistant resin more preferably includes a filler. By making the porous film including a heat-resistant resin include a heat-resistant resin containing chlorine atoms and also include a filler, the heat resistance of the separator can be further improved. When the porous film including a heat-resistant resin includes a filler, the amount of the filler is preferably 33 to 400 parts by weight per 100 parts by weight of the heat-resistant resin. The filler preferably includes at least one inorganic oxide selected from the group consisting of alumina, zeolite, silicon nitride, silicon carbide, titanium oxide, zirconium oxide, magnesium oxide, zinc oxide and silicon dioxide, because such inorganic oxide fillers are high in the resistance to the non-aqueous electrolyte and causes no side reactions adversely affecting the battery characteristics even at the redox potential. The inorganic oxide fillers are preferably chemically stable and high in purity.

The porous film including a heat-resistant resin can be prepared, for example, as follows. For example, a heat-resistant resin containing chlorine atoms is dissolved in a polar solvent such as N-methyl-2-pyrrolidone (NMP). Then, the obtained solution is coated on a substrate such as a glass plate and a stainless steel plate, and dried. By separating the obtained film from the substrate, a porous film including a heat-resistant resin can be obtained.

Additionally, by coating an NMP solution of a heat-resistant resin containing chlorine atoms on a porous film made of polyolefin and by drying the coated solution, a laminated film comprising a porous film including a heat-resistant resin and a porous film made of polyolefin can be prepared.

The porous film including a heat-resistant resin can be prepared, for example, as follows.

For example, a filler is added to an NMP solution of a heat-resistant resin containing chlorine atoms. The obtained mixture is coated on a predetermined substrate and dried. By peeling off the obtained dried film from the substrate, a porous film including a heat-resistant resin can be obtained.

A laminated film comprising a porous film including a heat-resistant resin and a filler and a porous film made of polyolefin can be prepared, for example, as follows.

For example, the filler is added to an NMP solution of the heat-resistant resin containing chlorine atoms. The obtained mixture is coated on a porous film made of polyolefin, and dried. Thus, a laminated film comprising a porous film including the heat-resistant resin and the filler and a porous film made of polyolefin can be obtained.

Next, the positive electrode is described.

The positive electrode active material layer constituting the positive electrode includes, according to need, a binder, a conductive agent and the like.

The positive electrode comprising a positive electrode current collector and a positive electrode active material layer carried thereon can be prepared, for example, as follows.

For example, a positive electrode active material, a binder and a predetermined dispersion medium, and, according to need, a conductive agent, a thickener and the like are mixed together to prepare a slurry. By coating the obtained slurry on the surface of the positive electrode current collector and by drying the coated slurry, the positive electrode can be prepared. The obtained positive electrode as it is may be subjected to roll forming into a sheet-shaped electrode.

Alternatively, the mixture including the positive electrode active material, the binder, the conductive agent and the like may be subjected to compression molding into a pellet-shaped electrode.

The binder used in the positive electrode is not particularly limited as long as the binder is a stable material with respect to the solvent and the non-aqueous electrolyte used at the time of preparing the positive electrode. Specific examples of the binder include polyvinylidene fluoride, polytetrafluoroethylene, styrene-butadiene rubber, isopropylene rubber, butadiene rubber and ethylene propylene rubber (EPDM).

Examples of the conductive agent include: metal materials such as copper and nickel; and carbon materials such as graphite and carbon black.

Examples of the thickener include carboxymethyl cellulose, methyl cellulose, hydroxymethyl cellulose, ethyl cellulose, polyvinyl alcohol, oxidized starch, phosphated starch and casein.

As the dispersion medium, water, N-methyl-2-pyrrolidone and the like can be used.

As the positive electrode current collector, metal foils of aluminum (Al), titanium (Ti), tantalum (Ta) and the like, or alloy foils containing the above-described elements can be used. Among these, Al foil or Al alloy foil are preferably used as the positive electrode current collector because these foils are light in weight and are capable of attaining high energy density.

Next, the negative electrode is described.

The negative electrode includes a negative electrode active material capable of absorbing and desorbing lithium. Examples of such a negative electrode active material include graphite material. The physical properties of graphite are not particularly limited as long as the absorption and desorption of lithium are possible.

Preferable among the graphite materials are an artificial graphite produced by high-temperature heat treatment of a graphitizable pitch, purified natural graphite, and materials obtained by surface treatment of such an artificial graphite and such a natural graphite as described above with pitch.

The negative electrode active material may include a second active material capable of absorbing and desorbing lithium in addition to such graphite materials as described above. Examples of the usable second active material include: non-graphite carbon materials such as non-graphitizable carbon and low-temperature baked carbon; metal oxide materials such as tin oxide and silicon oxide; and lithium metal and various lithium alloys.

It is to be noted that the negative electrode active material may include such a graphite material as described above and two or more of the second active materials.

The negative electrode comprising a negative electrode current collector and a negative electrode active material layer carried thereon can be prepared, for example, as follows.

For example, a negative electrode active material, a binder and a predetermined dispersion medium, and, according to need, a conductive agent, a thickener and the like are mixed together to prepare a paste. By coating the obtained paste on the surface of the negative electrode current collector and by drying the coated paste, the negative electrode can be prepared.

Similarly to the case of the positive electrode, the obtained negative electrode as it is may be subjected to roll forming into a sheet-shaped electrode. Alternatively, the mixture including the negative electrode active material, the binder, the conductive agent and the like may be subjected to compression molding into a pellet-shaped electrode.

As the negative electrode current collector, metal foils of copper (Cu), nickel (Ni), stainless steel and the like can be used. Among these, Cu foil is preferably used as the negative electrode current collector because copper is readily processed into thin film and low in cost.

The same binder, conductive agent and dispersion medium as used for the positive electrode can be used for the negative electrode.

Next, the non-aqueous electrolyte is described.

The non-aqueous electrolyte comprises a non-aqueous solvent and a solute dissolved therein. The non-aqueous solvent preferably includes a carbonic acid ester. Either cyclic carbonic acid esters or chain carbonic acid esters can be used.

As the cyclic carbonic acid ester, for example, propylene carbonate, ethylene carbonate and butylene carbonate are preferably used. These cyclic carbonic acid esters each have a high dielectric constant.

As the chain carbonic acid ester, for example, dimethyl carbonate, diethyl carbonate, ethyl methyl carbonate, di-n-propyl carbonate, methyl-n-propyl carbonate and ethyl-i-propyl carbonate are preferably used. These chain carbonic acid esters each have a low viscosity.

The above-described cyclic and chain carbonic acid esters may be used each alone or in combinations of two or more thereof.

Examples usable as the solute include: inorganic lithium salts such as LiClO₄, LiPF₆ and LiBF₄; and fluorine-containing organic lithium salts such as LiCF₃SO₃, LiN(CF₃SO₂)₂, LiN(CF₃CF₂SO₂)₂, LiN(CF₃SO₂)(C₄F₉SO₂) and LiC(CF₃SO₂)₃. These solutes may be used each alone or in combinations of two or more thereof. Among these solutes, LiPF₆ and LiBF₄ are preferable.

The solute is dissolved in a non-aqueous solvent in a concentration of usually 0.1 to 3.0 mol/L and preferably 0.5 to 2.0 mol/L.

The method for producing a non-aqueous electrolyte secondary battery comprising a positive electrode, a negative electrode, a separator and a non-aqueous electrolyte as described above is not particularly limited, and can be a method appropriately selected from usually adopted methods.

The shape of the non-aqueous electrolyte secondary battery is not particularly limited, and may be any of a coin shape, a button shape, a sheet shape, a cylinder shape, a flat shape and a rectangular shape. When the shape of the battery is a coin shape or a button shape, a pellet-shaped positive electrode and a pellet-shaped negative electrode are used. The sizes of the pellets are determined according to the size of the battery.

When the shape of the battery is a sheet shape, a cylinder shape or a rectangular shape, the positive electrode and the negative electrode each includes a current collector and an active material layer carried thereon. Additionally, in such a battery, the electrode plate group including the positive electrode, the separator and the negative electrode may be of a laminate or of a roll.

### EXAMPLES

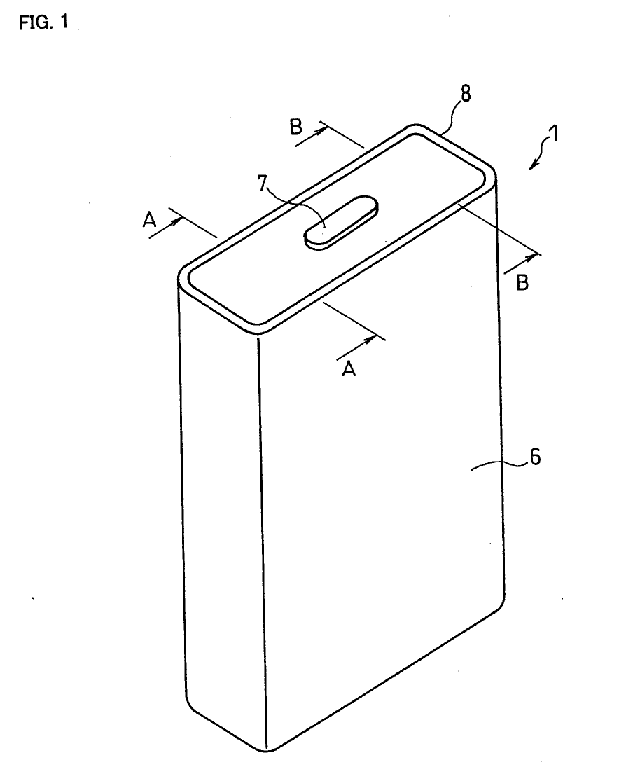

In the following example, a non-aqueous electrolyte secondary battery as illustrated in FIGS. 1 to 3 was produced.

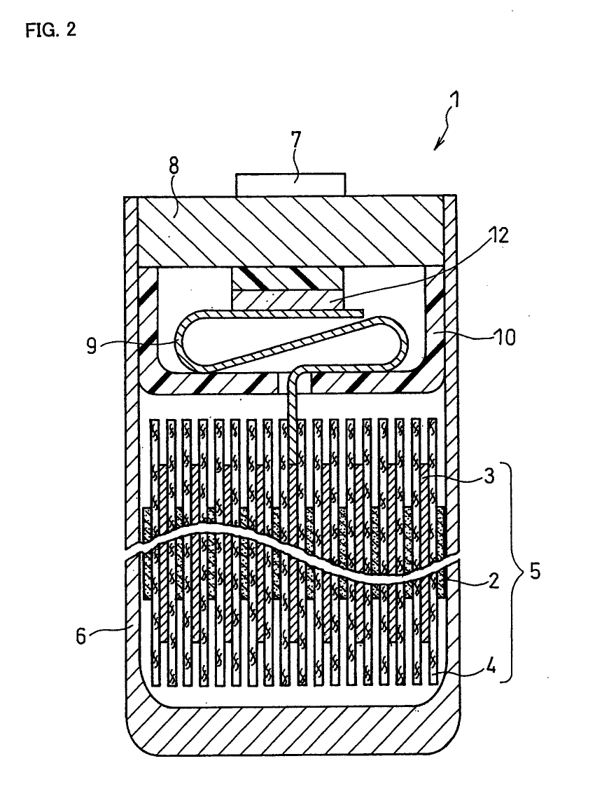

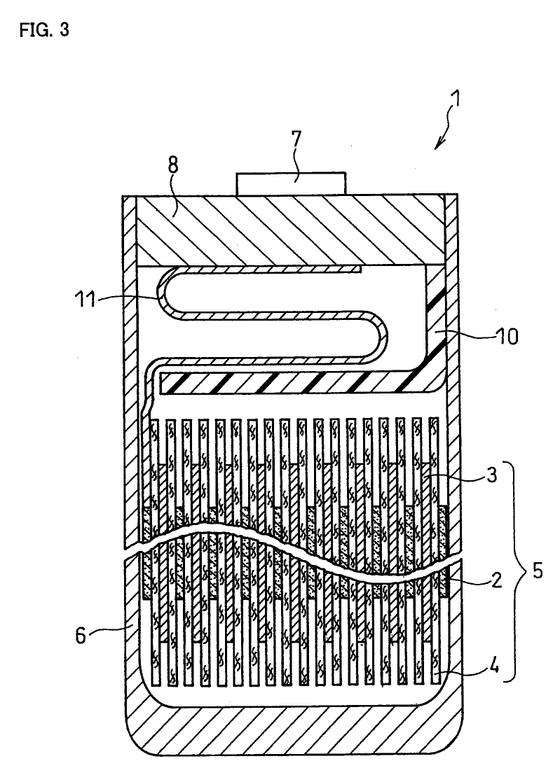

FIG. 1 shows an oblique perspective view of a flat rectangular battery 1, FIG. 2 shows a sectional view along the line A-A in FIG. 1, and FIG. 3 shows a sectional view along the line B-B in FIG. 1.

As shown in FIGS. 2 and 3, in the battery 1, an electrode plate group 5 including a positive electrode 2, a negative electrode 3 and a separator 4 interposed between the positive electrode 2 and the negative electrode 3, and a non-aqueous electrolyte are contained in a bottomed cylindrical battery case 6. As the separator, used is a separator made of a 20 μm thick polyethylene porous film. The battery case 6 is formed of aluminum (Al). The battery case 6 functions as the positive electrode terminal.

Above the electrode plate group 5, a resin framework 10 is disposed.

The opening end of the battery case 6 is laser-welded to a sealing plate 8 equipped with a negative electrode terminal 7 so as to seal the opening of the battery case 6. It is to be noted that the negative electrode terminal 7 is insulated from the sealing plate 8.

One end of a negative electrode nickel lead wire 9 is connected to the negative electrode. The other end of the negative electrode lead wire 9 is connected to the negative electrode terminal 7, and laser-welded to a portion 12 insulated from the sealing plate 8.

As shown in FIG. 3, one end of a positive electrode aluminum lead wire 11 is connected to the positive electrode. The other end of the positive electrode lead wire 11 is laser-welded to the opening-sealing plate 8.

The size of the produced battery was 50 mm in height, 34 mm in width and 5 mm in thickness. The battery capacity was 900 mAh.

The negative electrode was constituted with a negative electrode current collector and the negative electrode active material layers carried on the both surfaces of the negative electrode current collector. The negative electrode was prepared as follows.

As the negative electrode active material, a purified natural graphite subjected to surface treatment with pitch was used. The negative electrode active material, carboxymethyl cellulose as the thickener and styrene-butadiene rubber as the binder were mixed together in a weight ratio of 100:2:2. The obtained mixture and water as the dispersion medium were mixed together to prepare a negative electrode slurry. The negative electrode slurry was coated on the both surfaces of a negative electrode current collector made of a 10 μm thick copper foil as the current collector, and the coated slurry was dried at 200° C. to remove the water. Thereafter, the obtained negative electrode plate was rolled with a roll press, and cut to a predetermined dimension to prepare the negative electrode.

The non-aqueous electrolyte was prepared by dissolving LiPF₆ so as to have a concentration of 1 mol/L in a mixed solvent prepared by mixing ethyl carbonate and ethyl methyl carbonate in a volume ratio of 1:1.

As the positive electrode 2 included in the above-described battery, various positive electrodes as described below were used.

### Example 1

### (i) Preparation of LiNi_{1/3}Mn_{1/3}Co_{1/3}O₂ as Active Material B

To an aqueous solution prepared by dissolving nickel sulfate, manganese sulfate and cobalt sulfate in a molar ratio of 1:1:1, an aqueous solution of sodium hydroxide having a predetermined concentration was added to obtain a nickel (Ni)-manganese (Mn)-cobalt (Co) coprecipitated hydroxide. The Ni—Mn—Co coprecipitated hydroxide was filtered off, washed with water and dried in the air. The coprecipitated hydroxide having been dried was baked at 400° C. for 5 hours to obtain a Ni—Mn—Co oxide powder.

The obtained powder and a lithium carbonate powder were mixed together in a predetermined molar ratio. The obtained mixture was placed in a rotary kiln, and preheated in the air atmosphere at 650° C. for 10 hours. Successively, the mixture having been preheated was increased in temperature in an electric furnace up to 950° C. over a period of 2 hours, and thereafter baked at 950° C. for 10 hours. Consequently, LiNi_{1/3}Mn_{1/3}Co_{1/3}O₂ was obtained. The mean particle size of the obtained active material was 7.1 μm.

### (ii) Preparation of LiCoO₂ as Active Material A

To an aqueous solution of cobalt sulfate having a predetermined concentration, an aqueous solution of sodium hydroxide having a predetermined concentration was added to obtain a cobalt hydroxide. The obtained hydroxide was filtered off, washed with water and dried in the air. The hydroxide having been dried was baked at 500° C. for 5 hours to obtain a cobalt oxide powder.

The obtained powder and a lithium carbonate powder were mixed together. The obtained mixture was placed in a rotary kiln, and preheated in the air atmosphere at 650° C. for 10 hours. Successively, the mixture having been preheated was increased in temperature in an electric furnace up to 950° C. over a period of 2 hours, and thereafter baked at 950° C. for 10 hours. Consequently, LiCoO₂ was obtained. The mean particle size of the obtained active material was 6.8 μm.

### (iii) Preparation of Positive Electrode Active Material

The LiNi_{1/3}Mn_{1/3}Co_{1/3}O₂ prepared in the above (i) and the LiCoO₂ prepared in the above (ii) were mixed together in a weight ratio of 70:30 to obtain a positive electrode active material 1. The specific surface area and the tap density of the positive electrode active material 1 were 0.69 m²/g and 2.32 g/cm³, respectively.

### (iv) Preparation of Positive Electrode

The positive electrode active material 1, acetylene black as the conductive agent and polyvinylidene fluoride as the binder were mixed together in a weight ratio of 100:2:2. The obtained mixture and N-methyl-2-pyrrolidone (NMP) as the dispersion medium were mixed together to prepare a positive electrode slurry.

The positive electrode slurry was coated on the both surfaces of a positive electrode current collector made of a 15 μm thick Al foil, and the coated slurry was dried at 150° C. to remove the NMP. Thereafter, the obtained positive electrode plate was rolled with a roll press so as for the density of the active material in the positive electrode active material layer to be 3.5 g/cm³, and cut to a predetermined dimension to prepare the positive electrode.

By using the positive electrode prepared as described above, a battery A1 was produced.

### Example 2

### (v) Preparation of LiCo_{0.975}Mg_{0.02}Al_{0.005}O₂ as Active Material C

To an aqueous solution of cobalt sulfate, magnesium sulfate and aluminum sulfate in a molar ratio of 0.975:0.02:0.005, an aqueous solution of sodium hydroxide having a predetermined concentration was added to obtain a cobalt (Co)-magnesium (Mg)-aluminum (Al) coprecipitated hydroxide. The Co—Mg—Al coprecipitated hydroxide was filtered off, washed with water and dried in the air. The coprecipitated hydroxide having been dried was baked at 400° C. for 5 hours to obtain a Co—Mg—Al oxide powder.

The obtained powder and a lithium carbonate powder were mixed together in a predetermined molar ratio. The obtained mixture was placed in a rotary kiln, and preheated in the air atmosphere at 650° C. for 10 hours. Successively, the mixture having been preheated was increased in temperature in an electric furnace up to 950° C. over a period of 2 hours, and thereafter baked at 950° C. for 10 hours. Consequently, LiCo_{0.975}Mg_{0.02}Al_{0.005}O₂ was obtained. The mean particle size of the obtained active material was 6.9 μm.

The LiCo_{0.975}Mg_{0.02}Al_{0.005}O₂ prepared in the above (v) and the LiNi_{1/3}Mn_{1/3}Co_{1/3}O₂ prepared in the above (i) were mixed together in a weight ratio of 70:30 to obtain a positive electrode active material 2. The specific surface area and the tap density of the positive electrode active material 2 were 0.69 m²/g and 2.30 g/cm³, respectively.

A battery A2 was produced in the same manner as in Example 1 except that the positive electrode active material 2 was used.

### Example 3

A battery A3 was produced in the same manner as in Example 1 except that as the separator, a laminated film comprising a porous film (thickness: 16 μm) made of polyethylene (PE) and a porous film, made of aramid resin, carried thereon was used.

The above-described laminated film was prepared as follows.

To 100 parts by weight of NMP, 6.5 parts by weight of dried anhydrous calcium chloride (hereinafter abbreviated as CaCl₂) was added. The obtained mixture was heated to 80° C. in a reaction vessel and thus CaCl₂ was completely dissolved to obtain an NMP solution of CaCl₂.

The temperature of the NMP solution was brought back to room temperature, and then 3.2 parts by weight of paraphenylenediamine was added to the NMP solution and was completely dissolved therein. Thereafter, the reaction vessel containing the NMP solution was placed in a thermostat bath set at 20° C., 5.8 parts by weight of terephthalic acid dichloride was dropwise added to the NMP solution over a period of 1 hour, and thus poly-paraphenylene terephthalamide (PPTA) was synthesized by polymerization reaction. Thereafter, the reaction mixture was allowed to stand in the thermostat bath set at 20° C. for 1 hour.

After the completion of the polymerization reaction, the NMP solution containing PPTA was placed in a vacuum chamber, stirred under a reduced pressure for 30 minutes so as to be degassed. The obtained polymer-containing solution was diluted with an NMP solution of CaCl₂ to prepare an NMP solution of an aramid resin having a PPTA concentration of 1.4% by weight.

The obtained NMP solution of the aramid resin was thinly coated with a doctor blade on a porous film made of polyethylene, and dried with hot air set at 80° C. (wind velocity: 0.5 m/sec). The obtained aramid resin layer was sufficiently washed with purified water to eliminate the remaining CaCl₂. Thus, the aramid resin layer was made to be porous. Thereafter, the aramid resin layer was again dried. In this way, a laminated film (total thickness: 20 μm) comprising a porous film made of aramid and a porous film made of PE was prepared. The amount of the residual chlorine in this laminated film was measured by chemical analysis. Consequently, the amount of the residual chlorine was found to be 650 μg per 1 g of the laminated film.

### Example 4

A battery A4 was produced in the same manner as in Example 2 except that the separator used in Example 3 was used.

### Example 5

A battery A5 was produced in the same manner as in Example 1 except that as the separator, a laminated film comprising a porous film (thickness: 16 μm) made of PE and a porous film, made of amideimide resin, carried thereon was used.

The above-described laminated film was prepared as follows.

Trimellitic anhydride monochloride and a diamine were mixed together in NMP at room temperature to obtain an NMP solution of polyamide acid. This NMP solution of polyamide acid was thinly coated with a doctor blade on a porous film made of PE, and dried with hot air set at 80° C. (wind velocity: 0.5 m/sec) to subject the polyamide acid to dehydration ring-closing to prepare polyamideimide. In this way, a laminated film (total thickness: 20 μm) comprising a porous film made of amideimide and a porous film made of PE. The amount of the residual chlorine in this laminated film was measured by chemical analysis. Consequently, the amount of the residual chlorine was found to be 830 μg per 1 g of the separator.

### Example 6

A battery A6 was produced in the same manner as in Example 1 except that as the separator, a porous film made of an aramid resin was used.

The above-described porous film made of an aramid resin was prepared as follows.

The NMP solution of an aramid resin, prepared in Example 3, was coated with a doctor blade on a stainless steel plate having a flat and smooth surface, and dried with hot air set at 80° C. (wind velocity: 0.5 m/sec). In this way, a 20-μm thick porous film made of an aramid resin was obtained. The amount of the residual chlorine in the porous film was measured by chemical analysis. Consequently, the amount of this residual chlorine was found to be 1800 μg per 1 g of the separator.

### Example 7

A battery A7 was produced in the same manner as in Example 1 except that as the separator, a laminated film comprising a porous film (thickness: 16 μm) made of PE and a porous film, including an alumina fine particle filler and an aramid resin, carried thereon was used.

The above-described laminated film was prepared as follows.

In the NMP solution of an aramid resin, prepared in Example 3, 200 parts by weight of alumina fine particles were mixed. Thus, the NMP solution contained 100 parts by weight of a solid content.

The obtained dispersion was thinly coated with a doctor blade on a porous film made of PE, and dried with hot air set at 80° C. (wind velocity: 0.5 m/sec). In this way, a laminated film (total thickness: 20 μm) comprising a porous film made of PE and a porous film including a filler and aramid was obtained. The amount of the residual chlorine in this laminated film was measured by chemical analysis. Consequently, the amount of the residual chlorine was found to be 600 μg per 1 g of the separator.

### Example 8

The LiCoO₂ having a mean particle size of 6.8 μm and the LiNi_{1/3}Mn_{1/3}Co_{1/3}O₂ having a mean particle size of 7.1 μm were mixed together in a weight ratio of 90:10 to obtain a positive electrode active material 8. The specific surface area and the tap density of the positive electrode active material 8 were 0.69 m²/g and 2.34 g/cm³, respectively.

A battery A8 was produced in the same manner as in Example 1 except that the positive electrode active material 8 was used.

### Example 9

The LiCoO₂ having a mean particle size of 6.8 μm and the LiNi_{1/3}Mn_{1/3}Co_{1/3}O₂ having a mean particle size of 7.1 μm were mixed together in a weight ratio of 50:50 to obtain a positive electrode active material 9. The specific surface area and the tap density of the positive electrode active material 9 were 0.69 m²/g and 2.39 g/cm³, respectively.

A battery A9 was produced in the same manner as in Example 1 except that the positive electrode active material 9 was used.

### Example 10

The LiCoO₂ having a mean particle size of 6.8 μm and the LiNi_{1/3}Mn_{1/3}Co_{1/3}O₂ having a mean particle size of 7.1 μm were mixed together in a weight ratio of 30:70 to obtain a positive electrode active material 10. The specific surface area and the tap density of the positive electrode active material 10 were 0.68 m²/g and 2.41 g/cm³, respectively.

A battery A10 was produced in the same manner as in Example 1 except that the positive electrode active material 10 was used.

### Example 11

The LiCoO₂ having a mean particle size of 6.8 μm and the LiNi_{1/3}Mn_{1/3}Co_{1/3}O₂ having a mean particle size of 7.1 μm were mixed together in a weight ratio of 10:90 to obtain a positive electrode active material 11. The specific surface area and the tap density of the positive electrode active material 11 were 0.68 m²/g and 2.44 g/cm³, respectively.

A battery A11 was produced in the same manner as in Example 1 except that the positive electrode active material 11 was used.

### Example 12

LiNi_{0.5}Mn_{0.3}Co_{0.2}O₂ was obtained in the same manner as in (i) in Example 1 except that in the preparation of the active material B, an aqueous solution of nickel sulfate, manganese sulfate and cobalt sulfate in a molar ratio of 50:30:20 was used. The mean particle size of the obtained active material was 7.5 μm.

The LiCoO₂ having a mean particle size of 6.8 μm and the LiNi_{0.5}Mn_{0.3}Co_{0.2}O₂ were mixed together in a weight ratio of 70:30 to obtain a positive electrode active material 12. The specific surface area and the tap density of the positive electrode active material 12 were 0.63 m²/g and 2.56 g/cm³, respectively.

A battery A12 was produced in the same manner as in Example 1 except that the positive electrode active material 12 was used.

### Example 13

LiNi_{0.25}Mn_{0.25}Co_{0.5}O₂ was obtained in the same manner as in (i) in Example 1 except that in the preparation of the active material B, an aqueous solution of nickel sulfate, manganese sulfate and cobalt sulfate in a molar ratio of 25:25:50 was used. The mean particle size of the obtained active material was 7.8 μm.

The LiCoO₂ having a mean particle size of 6.8 μm and the LiNi_{0.25}Mn_{0.25}Co_{0.5}O₂ were mixed together in a weight ratio of 70:30 to obtain a positive electrode active material 13. The specific surface area and the tap density of the positive electrode active material 13 were 0.58 m²/g and 2.78 g/cm³, respectively.

A battery A13 was produced in the same manner as in Example 1 except that the positive electrode active material 13 was used.

### Example 14

LiNi_{0.4}Mn_{0.2}Co_{0.4}O₂ was obtained in the same manner as in (i) in Example 1 except that in the preparation of the active material B, an aqueous solution of nickel sulfate, manganese sulfate and cobalt sulfate in a molar ratio of 40:20:40 was used. The mean particle size of the obtained active material was 6.7 μm.

The LiCoO₂ having a mean particle size of 6.8 μm and the LiNi_{0.4}Mn_{0.2}Co_{0.4}O₂ were mixed together in a weight ratio of 70:30 to obtain a positive electrode active material 14. The specific surface area and the tap density of the positive electrode active material 14 were 0.72 m²/g and 2.28 g/cm³, respectively.

A battery A14 was produced in the same manner as in Example 1 except that the positive electrode active material 14 was used.

### Example 15

LiNi_{0.4}Mn_{0.4}Co_{0.2}O₂ was obtained in the same manner as in (i) in Example 1 except that in the preparation of the active material B, an aqueous solution of nickel sulfate, manganese sulfate and cobalt sulfate in a molar ratio of 40:40:20 was used. The mean particle size of the obtained active material was 6.9 μm.

The LiCoO₂ having a mean particle size of 6.8 μm and the LiNi_{0.4}Mn_{0.4}Co_{0.2}O₂ were mixed together in a weight ratio of 70:30 to obtain a positive electrode active material 15. The specific surface area and the tap density of the positive electrode active material 15 were 0.71 m²/g and 2.28 g/cm³, respectively.

A battery A15 was produced in the same manner as in Example 1 except that the positive electrode active material 15 was used.

### Example 16

LiNi_{1/3}Mn_{1/3}Mg_{1/3}O₂ was obtained in the same manner as in (i) in Example 1 except that in the preparation of the active material B, magnesium sulfate was used in place of cobalt sulfate. The mean particle size of the obtained active material was 7.1 μm.

The LiCoO₂ having a mean particle size of 6.8 μm and the LiNi_{1/3}Mn_{1/3}Mg_{1/3}O₂ were mixed together in a weight ratio of 70:30 to obtain a positive electrode active material 16. The specific surface area and the tap density of the positive electrode active material 16 were 0.69 m²/g and 2.30 g/cm³, respectively.

A battery A16 was produced in the same manner as in Example 1 except that the positive electrode active material 16 was used.

### Example 17

LiNi_{1/3}Mn_{1/3}Al_{1/3}O₂ was obtained in the same manner as in (i) in Example 1 except that in the preparation of the active material B, aluminum sulfate was used in place of cobalt sulfate. The mean particle size of the obtained active material was 7.5 μm.

The LiCoO₂ having a mean particle size of 6.8 μm and the LiNi_{1/3}Mn_{1/3}Al_{1/3}O₂ were mixed together in a weight ratio of 70:30 to obtain a positive electrode active material 17. The specific surface area and the tap density of the positive electrode active material 17 were 0.69 m²/g and 2.25 g/cm³, respectively.

A battery A17 was produced in the same manner as in Example 1 except that the positive electrode active material 17 was used.

### Example 18

A positive electrode was obtained in the same manner as in Example 1 except that the density of the active material in the active material layer after pressing the positive electrode plate was set at 3.25 g/cm³. A battery A18 was produced by using this positive electrode.

### Example 19

A positive electrode was obtained in the same manner as in Example 1 except that the density of the active material in the active material layer after pressing the positive electrode plate was set at 3.3 g/cm³. A battery A19 was produced by using this positive electrode.

### Example 20

A positive electrode was obtained in the same manner as in Example 1 except that the density of the active material in the active material layer after pressing the positive electrode plate was set at 3.7 g/cm³. A battery A20 was produced by using this positive electrode.

### Example 21

LiCoO₂, as the active material A, having a mean particle size of 2.6 μm was obtained in the same manner as in (ii) in Example 1 except that the baking temperature and the baking time were altered.

The LiCoO₂ having a mean particle size of 2.6 μm and the LiNi_{1/3}Mn_{1/3}Co_{1/3}O₂ having a mean particle size of 7.1 μm were mixed together in a weight ratio of 70:30 to obtain a positive electrode active material 21. The specific surface area and the tap density of the positive electrode active material 21 were 0.87 m²/g and 2.00 g/cm³, respectively.

A battery A21 was produced in the same manner as in Example 1 except that the positive electrode active material 21 was used.

### Example 22

LiCoO₂, as the active material A, having a mean particle size of 3.3 μm was obtained in the same manner as in (ii) in Example 1 except that the baking temperature and the baking time were altered.

The LiCoO₂ having a mean particle size of 3.3 μm and the LiNi_{1/3}Mn_{1/3}Co_{1/3}O₂ having a mean particle size of 7.1 μm were mixed together in a weight ratio of 70:30 to obtain a positive electrode active material 22. The specific surface area and the tap density of the positive electrode active material 22 were 0.80 m²/g and 2.11 g/cm³, respectively.

A battery A22 was produced in the same manner as in Example 1 except that the positive electrode active material 22 was used.

### Example 23

LiCoO₂, as the active material A, having a mean particle size of 11.8 μm was obtained in the same manner as in (ii) in Example 1 except that the baking temperature and the baking time were altered.

The LiCoO₂ having a mean particle size of 11.8 μm and the LiNi_{1/3}Mn_{1/3}Co_{1/3}O₂ having a mean particle size of 7.1 μm were mixed together in a weight ratio of 70:30 to obtain a positive electrode active material 23. The specific surface area and the tap density of the positive electrode active material 23 were 0.54 m²/g and 2.71 g/cm³, respectively.

A battery A23 was produced in the same manner as in Example 1 except that the positive electrode active material 23 was used.

### Example 24

LiCoO₂, as the active material A, having a mean particle size of 12.9 μm was obtained in the same manner as in (ii) in Example 1 except that the baking temperature and the baking time were altered.

The LiCoO₂ having a mean particle size of 12.9 μm and the LiNi_{1/3}Mn_{1/3}Co_{1/3}O₂ having a mean particle size of 7.1 μm were mixed together in a weight ratio of 70:30 to obtain a positive electrode active material 24. The specific surface area and the tap density of the positive electrode active material 24 were 0.49 m²/g and 2.77 g/cm³, respectively.

A battery A24 was produced in the same manner as in Example 1 except that the positive electrode active material 24 was used.

### Example 25

LiNi_{1/3}Mn_{1/3}Co_{1/3}O₂, as the active material B, having a mean particle size of 2.4 μm was obtained in the same manner as in (i) in Example 1 except that the baking temperature and the baking time were altered.

The LiCoO₂ having a mean particle size of 6.8 μm and the above-described LiNi_{1/3}Mn_{1/3}Co_{1/3}O₂ having a mean particle size of 2.4 μm were mixed together in a weight ratio of 70:30 to obtain a positive electrode active material 25. The specific surface area and the tap density of the positive electrode active material 25 were 0.93 m²/g and 2.10 g/cm³, respectively.

A battery A25 was produced in the same manner as in Example 1 except that the positive electrode active material 25 was used.

### Example 26

LiNi_{1/3}Mn_{1/3}Co_{1/3}O₂, as the active material B, having a mean particle size of 3.1 μm was obtained in the same manner as in (i) in Example 1 except that the baking temperature and the baking time were altered.

The LiCoO₂ having a mean particle size of 6.8 μm and the above-described LiNi_{1/3}Mn_{1/3}Co_{1/3}O₂ having a mean particle size of 3.1 μm were mixed together in a weight ratio of 70:30 to obtain a positive electrode active material 26. The specific surface area and the tap density of the positive electrode active material 26 were 0.83 m²/g and 2.21 g/cm³, respectively.

A battery A26 was produced in the same manner as in Example 1 except that the positive electrode active material 26 was used.

### Example 27

LiNi_{1/3}Mn_{1/3}Co_{1/3}O₂, as the active material B, having a mean particle size of 11.5 μm was obtained in the same manner as in (i) in Example 1 except that the baking temperature and the baking time were altered.

The LiCoO₂ having a mean particle size of 6.8 μm and the above-described LiNi_{1/3}Mn_{1/3}Co_{1/3}O₂ having a mean particle size of 11.5 μm were mixed together in a weight ratio of 70:30 to obtain a positive electrode active material 27. The specific surface area and the tap density of the positive electrode active material 27 were 0.49 m²/g and 2.61 g/cm³, respectively.

A battery A27 was produced in the same manner as in Example 1 except that the positive electrode active material 27 was used.

### Example 28

LiNi_{1/3}Mn_{1/3}Co_{1/3}O₂, as the active material B, having a mean particle size of 13.2 μm was obtained in the same manner as in (i) in Example 1 except that the baking temperature and the baking time were altered.

The LiCoO₂ having a mean particle size of 6.8 μm and the above-described LiNi_{1/3}Mn_{1/3}Co_{1/3}O₂ having a mean particle size of 13.2 μm were mixed together in a weight ratio of 70:30 to obtain a positive electrode active material 28. The specific surface area and the tap density of the positive electrode active material 28 were 0.43 m²/g and 2.69 g/cm³, respectively.

A battery A28 was produced in the same manner as in Example 1 except that the positive electrode active material 28 was used.

### Example 29

LiCoO₂, as the active material A, having a mean particle size of 10.9 μm was obtained in the same manner as in (ii) in Example 1 except that the baking temperature and the baking time were altered.

LiNi_{1/3}Mn_{1/3}Co_{1/3}O₂, as the active material B, having a mean particle size of 10.5 μm was obtained in the same manner as in (i) in Example 1 except that the baking temperature and the baking time were altered.

The LiCoO₂ having a mean particle size of 10.9 μm and the LiNi_{1/3}Mn_{1/3}Co_{1/3}O₂ having a mean particle size of 10.5 μm were mixed together in a weight ratio of 70:30 to obtain a positive electrode active material 29. The specific surface area and the tap density of the positive electrode active material 29 were 0.33 m²/g and 3.01 g/cm³, respectively.

A battery A29 was produced in the same manner as in Example 1 except that the positive electrode active material 29 was used.

### Example 30

LiCoO₂, as the active material A, having a mean particle size of 9.8 μm was obtained in the same manner as in (ii) in Example 1 except that the baking temperature and the baking time were altered.

LiNi_{1/3}Mn_{1/3}Co_{1/3}O₂, as the active material B, having a mean particle size of 10.1 μm was obtained in the same manner as in (i) in Example 1 except that the baking temperature and the baking time were altered.

The LiCoO₂ having a mean particle size of 9.8 μm and the LiNi_{1/3}Mn_{1/3}Co_{1/3}O₂ having a mean particle size of 10.1 μm were mixed together in a weight ratio of 70:30 to obtain a positive electrode active material 30. The specific surface area and the tap density of the positive electrode active material 30 were 0.41 m²/g and 2.88 g/cm³, respectively.

A battery A30 was produced in the same manner as in Example 1 except that the positive electrode active material 30 was used.

### Example 31

LiCoO₂, as the active material A, having a mean particle size of 4.1 μm was obtained in the same manner as in (ii) in Example 1 except that the baking temperature and the baking time were altered.

LiNi_{1/3}Mn_{1/3}Co_{1/3}O₂, as the active material B, having a mean particle size of 4.5 μm was obtained in the same manner as in (i) in Example 1 except that the baking temperature and the baking time were altered.

The LiCoO₂ having a mean particle size of 4.1 μm and the LiNi_{1/3}Mn_{1/3}Co_{1/3}O₂ having a mean particle size of 4.5 μm were mixed together in a weight ratio of 70:30 to obtain a positive electrode active material 31. The specific surface area and the tap density of the positive electrode active material 31 were 1.19 m²/g and 1.91 g/cm³, respectively.

A battery A31 was produced in the same manner as in Example 1 except that the positive electrode active material 31 was used.

### Example 32

LiCoO₂, as the active material A, having a mean particle size of 3.6 μm was obtained in the same manner as in (ii) in Example 1 except that the baking temperature and the baking time were altered.

LiNi_{1/3}Mn_{1/3}Co_{1/3}O₂, as the active material B, having a mean particle size of 3.4 μm was obtained in the same manner as in (i) in Example 1 except that the baking temperature and the baking time were altered.

The LiCoO₂ having a mean particle size of 3.6 μm and the LiNi_{1/3}Mn_{1/3}Co_{1/3}O₂ having a mean particle size of 3.4 μm were mixed together in a weight ratio of 70:30 to obtain a positive electrode active material 32. The specific surface area and the tap density of the positive electrode active material 32 were 1.31 m²/g and 1.83 g/cm³, respectively.

A battery A32 was produced in the same manner as in Example 1 except that the positive electrode active material 32 was used.

### Example 33

The LiCo_{0.975}Mg_{0.02}Al_{0.005}O₂ having a mean particle size of 6.9 μm and the LiNi_{1/3}Mn_{1/3}Co_{1/3}O₂ having a mean particle size of 7.1 μm were mixed together in a weight ratio of 90:10 to obtain a positive electrode active material 33. The specific surface area and the tap density of the positive electrode active material 33 were 0.69 m²/g and 2.32 g/cm³, respectively.

A battery A33 was produced in the same manner as in Example 1 except that the positive electrode active material 33 was used.

### Example 34

The LiCo_{0.975}Mg_{0.02}Al_{0.005}O₂ having a mean particle size of 6.9 μm and the LiNi_{1/3}Mn_{1/3}Co_{1/3}O₂ having a mean particle size of 7.1 μm were mixed together in a weight ratio of 50:50 to obtain a positive electrode active material 34. The specific surface area and the tap density of the positive electrode active material 34 were 0.69 m²/g and 2.35 g/cm³, respectively.

A battery A34 was produced in the same manner as in Example 1 except that the positive electrode active material 34 was used.

### Example 35

The LiCo_{0.975}Mg_{0.02}Al_{0.005}O₂ having a mean particle size of 6.9 μm and the LiNi_{1/3}Mn_{1/3}Co_{1/3}O₂ having a mean particle size of 7.1 μm were mixed together in a weight ratio of 30:70 to obtain a positive electrode active material 35. The specific surface area and the tap density of the positive electrode active material 35 were 0.68 m²/g and 2.40 g/cm³, respectively.

A battery A35 was produced in the same manner as in Example 1 except that the positive electrode active material 35 was used.

### Example 36

The LiCo_{0.975}Mg_{0.02}Al_{0.005}O₂ having a mean particle size of 6.9 μm and the LiNi_{1/3}Mn_{1/3}Co_{1/3}O₂ having a mean particle size of 7.1 μm were mixed together in a weight ratio of 10:90 to obtain a positive electrode active material 36. The specific surface area and the tap density of the positive electrode active material 36 were 0.68 m²/g and 2.43 g/cm³, respectively.

A battery A36 was produced in the same manner as in Example 1 except that the positive electrode active material 36 was used.

### Example 37

LiCo_{0.975}Mg_{0.025}O₂, as the active material C, was obtained in the same manner as in Example 2 except that an aqueous solution of cobalt sulfate and magnesium sulfate in a molar ratio of 0.975:0.025 was used. The mean particle size of the obtained active material C was 7.0 μm.

The LiCo_{0.975}Mg_{0.025}O₂ having a mean particle size of 7.0 μm and the LiNi_{1/3}Mn_{1/3}Co_{1/3}O₂ having a mean particle size of 7.1 μm were mixed together in a weight ratio of 70:30 to obtain a positive electrode active material 37. The specific surface area and the tap density of the positive electrode active material 37 were 0.70 m²/g and 2.32 g/cm³, respectively.

A battery A37 was produced in the same manner as in Example 1 except that the positive electrode active material 37 was used.

### Example 38

LiCo_{0.975}Al_{0.025}O₂, as the active material C, was obtained in the same manner as in Example 2 except that an aqueous solution of cobalt sulfate and aluminum sulfate in a molar ratio of 0.975:0.025 was used. The mean particle size of the obtained active material C was 6.8 μm.

The LiCo_{0.975}Al_{0.025}O₂ having a mean particle size of 6.8 μm and the LiNi_{1/3}Mn_{1/3}Co_{1/3}O₂ having a mean particle size of 7.1 μm were mixed together in a weight ratio of 70:30 to obtain a positive electrode active material 38. The specific surface area and the tap density of the positive electrode active material 38 were 0.67 m²/g and 2.33 g/cm³, respectively.

A battery A38 was produced in the same manner as in Example 1 except that the positive electrode active material 38 was used.

### Example 39

LiCo_{0.975}Mg_{0.02}Zr_{0.005}O₂, as the active material C, was obtained in the same manner as in Example 2 except that an aqueous solution of cobalt sulfate, magnesium sulfate and zirconium sulfate in a molar ratio of 0.975:0.02:0.005 was used. The mean particle size of the obtained active material C was 6.7 μm.

The LiCo_{0.975}Mg_{0.02}Zr_{0.005}O₂ having a mean particle size of 6.7 μm and the LiNi_{1/3}Mn_{1/3}Co_{1/3}O₂ having a mean particle size of 7.1 μm were mixed together in a weight ratio of 70:30 to obtain a positive electrode active material 39. The specific surface area and the tap density of the positive electrode active material 39 were 0.70 m²/g and 2.31 g/cm³, respectively.

A battery A39 was produced in the same manner as in Example 1 except that the positive electrode active material was used.

### Example 40

LiCo_{0.975}Mg_{0.02}Mo_{0.005}O₂, as the active material C, was obtained in the same manner as in Example 2 except that an aqueous solution of cobalt sulfate, magnesium sulfate and molybdenum sulfate in a molar ratio of 0.975:0.02:0.005 was used. The mean particle size of the obtained active material C was 6.9 μm.

The LiCo_{0.975}Mg_{0.02}Mo_{0.005}O₂ having a mean particle size of 6.9 μm and the LiNi_{1/3}Mn_{1/3}Co_{1/3}O₂ having a mean particle size of 7.1 μm were mixed together in a weight ratio of 70:30 to obtain a positive electrode active material 40. The specific surface area and the tap density of the positive electrode active material 40 were 0.67 m²/g and 2.34 g/cm³, respectively.

A battery A40 was produced in the same manner as in Example 1 except that the positive electrode active material 40 was used.

### Example 41

LiCo_{0.995}Mg_{0.003}Al_{0.002}O₂, as the active material C, was obtained in the same manner as in Example 2 except that an aqueous solution of cobalt sulfate, magnesium sulfate and aluminum sulfate in a molar ratio of 0.995:0.003:0.002 was used. The mean particle size of the obtained active material C was 6.6 μm.

The LiCo_{0.995}Mg_{0.003}Al_{0.002}O₂ having a mean particle size of 6.6 μm and the LiNi_{1/3}Mn_{1/3}Co_{1/3}O₂ having a mean particle size of 7.1 μm were mixed together in a weight ratio of 70:30 to obtain a positive electrode active material 41. The specific surface area and the tap density of the positive electrode active material 41 were 0.70 m²/g and 2.27 g/cm³, respectively.

A battery A41 was produced in the same manner as in Example 1 except that the positive electrode active material 41 was used.

### Example 42

LiCo_{0.9}Mg_{0.095}Al_{0.005}O₂, as the active material C, was obtained in the same manner as in Example 2 except that an aqueous solution of cobalt sulfate, magnesium sulfate and aluminum sulfate in a molar ratio of 0.9:0.095:0.005 was used. The mean particle size of the obtained active material C was 7.0 μm.

The LiCo_{0.9}Mg_{0.095}Al_{0.005}O₂ having a mean particle size of 7.0 μm and the LiNi_{1/3}Mn_{1/3}Co_{1/3}O₂ having a mean particle size of 7.1 μm were mixed together in a weight ratio of 70:30 to obtain a positive electrode active material 42. The specific surface area and the tap density of the positive electrode active material 42 were 0.67 m²/g and 2.30 g/cm³, respectively.

A battery A42 was produced in the same manner as in Example 1 except that the positive electrode active material 42 was used.

### Example 43

LiNi_{0.27}Mn_{0.3}Co_{0.43}O₂ was obtained in the same manner as in (i) in Example 1 except that in the preparation of the active material B, an aqueous solution of nickel sulfate, manganese sulfate and cobalt sulfate in a molar ratio of 27:30:43 was used. The mean particle size of the obtained active material was 7.6 μm.

The LiCoO₂ having a mean particle size of 6.8 μm and the above-described LiNi_{0.27}Mn_{0.3}Co_{0.43}O₂ having a mean particle size of 7.6 μm were mixed together in a weight ratio of 70:30 to obtain a positive electrode active material 43. The specific surface area and the tap density of the positive electrode active material 43 were 0.61 m²/g and 2.61 g/cm³, respectively.

A battery A43 was produced in the same manner as in Example 1 except that the positive electrode active material 43 was used.

### Example 44

LiNi_{0.5}Mn_{0.2}Co_{0.3}O₂ was obtained in the same manner as in (i) in Example 1 except that in the preparation of the active material B, an aqueous solution of nickel sulfate, manganese sulfate and cobalt sulfate in a molar ratio of 50:20:30 was used. The mean particle size of the obtained active material was 7.4 μm.

The LiCoO₂ having a mean particle size of 6.8 μm and the above-described LiNi_{0.5}Mn_{0.2}Co_{0.3}O₂ having a mean particle size of 7.4 μm were mixed together in a weight ratio of 70:30 to obtain a positive electrode active material 44. The specific surface area and the tap density of the positive electrode active material 44 were 0.65 m²/g and 2.45 g/cm³, respectively.

A battery A44 was produced in the same manner as in Example 1 except that the positive electrode active material was used.

### Comparative Example 1

A comparative battery B1 was produced in the same manner as in Example 1 except that the LiCoO₂ having a mean particle size of 6.8 μm was used as the positive electrode active material.

### Comparative Example 2

A comparative battery B2 was produced in the same manner as in Example 1 except that the LiCo_{0.975}Mg_{0.02}Al_{0.005}O₂ having a mean particle size of 6.9 μm was used as the positive electrode active material.

### Comparative Example 3

A comparative battery B3 was produced in the same manner as in Example 1 except that the LiCo_{0.995}Mg_{0.003}Al_{0.002}O₂ having a mean particle size of 6.6 μm was used as the positive electrode active material.

### Comparative Example 4

A comparative battery B4 was produced in the same manner as in Example 1 except that the LiCo_{0.9}Mg_{0.095}Al_{0.005}O₂ having a mean particle size of 7.0 μm was used as the positive electrode active material.

### Comparative Example 5

A comparative battery B5 was produced in the same manner as in Example 1 except that the LiNi_{1/3}Mn_{1/3}Co_{1/3}O₂ having a mean particle size of 7.1 μm was used as the positive electrode active material.

### Comparative Example 6

LiNi_{0.05}Mn_{0.5}O₂ was obtained in the same manner as in (i) in Example 1 except that in the preparation of the active material B, an aqueous solution of nickel sulfate and manganese sulfate in a molar ratio of 1:1 was used. The mean particle size of the obtained active material B was 6.2 μm.

The LiCoO₂ having a mean particle size of 6.8 μm and the above-described LiNi_{0.5}Mn_{0.5}O₂ were mixed together in a weight ratio of 70:30 to obtain a positive electrode active material. The specific surface area and the tap density of the obtained positive electrode active material were 0.60 m²/g and 2.43 g/cm³, respectively.

A comparative battery B6 was produced in the same manner as in Example 1 except that this positive electrode active material was used.

### Comparative Example 7

LiNi_{0.45}Mn_{0.45}Co_{0.1}O₂ was obtained in the same manner as in (i) in Example 1 except that in the preparation of the active material B, an aqueous solution of nickel sulfate, manganese sulfate and cobalt sulfate in a molar ratio of 45:45:10 was used. The mean particle size of the obtained active material B was 6.4 μm.

The LiCoO₂ having a mean particle size of 6.8 μm and the above-described LiNi_{0.45}Mn_{0.45}Co_{0.1}O₂ were mixed together in a weight ratio of 70:30 to obtain a positive electrode active material. The specific surface area and the tap density of this positive electrode active material were 0.62 m²/g and 2.40 g/cm³, respectively.

A comparative battery B7 was produced in the same manner as in Example 1 except that the positive electrode active material was used.

### Comparative Example 8

LiNi_{0.24}Mn_{0.3}Co_{0.46}O₂ was obtained in the same manner as in (i) in Example 1 except that in the preparation of the active material B, an aqueous solution of nickel sulfate, manganese sulfate and cobalt sulfate in a molar ratio of 24:30:46 was used. The mean particle size of the obtained active material was 7.7 μm.

The LiCoO₂ having a mean particle size of 6.8 μm and the above-described LiNi_{0.24}Mn_{0.3}Co_{0.46}O₂ having a mean particle size of 7.7 μm were mixed together in a weight ratio of 70:30 to obtain a positive electrode active material. The specific surface area and the tap density of this positive electrode active material were 0.60 m²/g and 2.63 g/cm³, respectively.

A comparative battery B8 was produced in the same manner as in Example 1 except that the positive electrode active material was used.

### Comparative Example 9

LiNi_{0.55}Mn_{0.2}Co_{0.25}O₂ was obtained in the same manner as in (i) in Example 1 except that in the preparation of the active material B, an aqueous solution of nickel sulfate, manganese sulfate and cobalt sulfate in a molar ratio of 55:20:25 was used. The mean particle size of the obtained active material was 7.7 μm.

The LiCoO₂ having a mean particle size of 6.8 μm and the above-described LiNi_{0.55}Mn_{0.2}Co_{0.25}O₂ having a mean particle size of 7.7 μm were mixed together in a weight ratio of 70:30 to obtain a positive electrode active material. The specific surface area and the tap density of this positive electrode active material were 0.62 m²/g and 2.45 g/cm³, respectively.

A comparative battery B9 was produced in the same manner as in Example 1 except that the positive electrode active material was used.

Tables 1 to 4 show the types and physical properties of the positive electrode active materials and the constituent material of the separators included in the batteries A1 to A44 and the comparative batteries B1 to B9.

TABLE 1

| | | Mixing proportion | | Mixing proportion | Constituent |
|---|---|---|---|---|---|
| | Active material | of active material | Active material | of active material | material of |
| Battery | A or C | A or C (% by weight) | B | B (% by weight) | separator |
| A1 | LiCoO₂ | 70 | LiNi_{1/3}Mn_{1/3}Co_{1/3}O₂ | 30 | PE |
| A2 | LiCo_{0.975}Mg_{0.02}Al_{0.005}O₂ | 70 | LiNi_{1/3}Mn_{1/3}Co_{1/3}O₂ | 30 | PE |
| A3 | LiCoO₂ | 70 | LiNi_{1/3}Mn_{1/3}Co_{1/3}O₂ | 30 | Laminated film⁽¹⁾ |
| A4 | LiCo_{0.975}Mg_{0.02}Al_{0.005}O₂ | 70 | LiNi_{1/3}Mn_{1/3}Co_{1/3}O₂ | 30 | Laminated film⁽¹⁾ |
| A5 | LiCoO₂ | 70 | LiNi_{1/3}Mn_{1/3}Co_{1/3}O₂ | 30 | Laminated film⁽²⁾ |
| A6 | LiCoO₂ | 70 | LiNi_{1/3}Mn_{1/3}CO_{1/3}O₂ | 30 | Aramid resin |
| A7 | LiCoO₂ | 70 | LiNi_{1/3}Mn_{1/3}Co_{1/3}O₂ | 30 | Laminated film⁽³⁾ |
| A8 | LiCoO₂ | 90 | LiNi_{1/3}Mn_{1/3}Co_{1/3}O₂ | 10 | PE |
| A9 | LiCoO₂ | 50 | LiNi_{1/3}Mn_{1/3}Co_{1/3}O₂ | 50 | PE |
| A10 | LiCoO₂ | 30 | LiNi_{1/3}Mn_{1/3}Co_{1/3}O₂ | 70 | PE |
| A11 | LiCoO₂ | 10 | LiNi_{1/3}Mn_{1/3}Co_{1/3}O₂ | 90 | PE |
| A12 | LiCoO₂ | 70 | LiNi_{o.5}Mn_{0.3}Co_{0.2}O₂ | 30 | PE |
| A13 | LiCoO₂ | 70 | LiNi_{0.25}Mn_{0.25}Co_{0.5}O₂ | 30 | PE |
| A14 | LiCoO₂ | 70 | LiNi_{0.4}Mn_{0.2}Co_{0.4}O₂ | 30 | PE |
| A15 | LiCoO₂ | 70 | LiNi_{0.4}Mn_{0.4}Co_{0.2}C₂ | 30 | PE |
| A16 | LiCoO₂ | 70 | LiNi_{1/3}Mn_{1/3}Mg_{1/3}O₂ | 30 | PE |
| A17 | LiCoO₂ | 70 | LiNi_{1/3}Mn_{1/3}Al_{1/3}O₂ | 30 | PE |
| A18 | LiCoO₂ | 70 | LiNi_{1/3}Mn_{1/3}Co_{1/3}O₂ | 30 | PE |
| A19 | LiCoO₂ | 70 | LiNi_{1/3}Mn_{1/3}Co_{1/3}O₂ | 30 | PE |
| A20 | LiCoO₂ | 70 | LiNi_{1/3}Mn_{1/3}Co_{1/3}O₂ | 30 | PE |
| A21 | LiCoO₂ | 70 | LiNi_{1/3}Mn_{1/3}Co_{1/3}O₂ | 30 | PE |
| A22 | LiCoO₂ | 70 | LiNi_{1/3}Mn_{1/3}Co_{1/3}O₂ | 30 | PE |
| A23 | LiCoO₂ | 70 | LiNi_{1/3}Mn_{1/3}Co_{1/3}O₂ | 30 | PE |
| A24 | LiCoO₂ | 70 | LiNi_{1/3}Mn_{1/3}Co_{1/3}O₂ | 30 | PE |

Laminated film⁽¹⁾: Comprising a porous film made of PE and a porous film made of an aramid resin.
Laminated film⁽²⁾: Comprising a porous film made of PE and a porous film made of an amideimide resin.
Laminated film⁽³⁾: Comprising a porous film made of PE and a porous film including an alumina fine particle filler and an aramid resin.

TABLE 2

| | | Mixing proportion | | Mixing proportion | Constituent |
|---|---|---|---|---|---|
| | Active material | of active material | Active material | of active material | material of |
| Battery | A or C | A or C (% by weight) | B | B (% by weight) | separator |
| A25 | LiCoO₂ | 70 | LiNi_{1/3}Mn_{1/3}Co_{1/3}O₂ | 30 | PE |
| A26 | LiCoO₂ | 70 | LiNi_{1/3}Mn_{1/3}Co_{1/3}O₂ | 30 | PE |
| A27 | LiCoO₂ | 70 | LiNi_{1/3}Mn_{1/3}Co_{1/3}O₂ | 30 | PE |
| A28 | LiCoO₂ | 70 | LiNi_{1/3}Mn_{1/3}Co_{1/3}O₂ | 30 | PE |
| A29 | LiCoO₂ | 70 | LiNi_{1/3}Mn_{1/3}Co_{1/3}O₂ | 30 | PE |
| A30 | LiCoO₂ | 70 | LiNi_{1/3}Mn_{1/3}Co_{1/3}O₂ | 30 | PE |
| A31 | LiCoO₂ | 70 | LiNi_{1/3}Mn_{1/3}Co_{1/3}O₂ | 30 | PE |
| A32 | LiCoO₂ | 70 | LiNi_{1/3}Mn_{1/3}Co_{1/3}O₂ | 30 | PE |
| A33 | LiCo_{0.975}Mg_{0.02}Al_{0.005}O₂ | 90 | LiNi_{1/3}Mn_{1/3}Co_{1/3}O₂ | 10 | PE |
| A34 | LiCo_{0.975}Mg_{0.02}Al_{0.005}O₂ | 50 | LiNi_{1/3}Mn_{1/3}Co_{1/3}O₂ | 50 | PE |
| A35 | LiCo_{0.975}Mg_{0.02}Al_{0.005}O₂ | 30 | LiNi_{1/3}Mn_{1/3}Co_{1/3}O₂ | 70 | PE |
| A36 | LiCo_{0.975}Mg_{0.02}Al_{0.005}O₂ | 10 | LiNi_{1/3}Mn_{1/3}Co_{1/3}O₂ | 90 | PE |
| A37 | LiCo_{0.975}Mg_{0.025}O₂ | 70 | LiNi_{1/3}Mn_{1/3}Co_{1/3}O₂ | 30 | PE |
| A38 | LiCo_{0.975}Al_{0.025}O₂ | 70 | LiNi_{1/3}Mn_{1/3}Co_{1/3}O₂ | 30 | PE |
| A39 | LiCo_{0.975}Mg_{0.02}Zr_{0.005}O₂ | 70 | LiNi_{1/3}Mn_{1/3}Co_{1/3}O₂ | 30 | PE |
| A40 | LiCo_{0.975}Mg_{0.02}Mo_{0.005}O₂ | 70 | LiNi_{1/3}Mn_{1/3}Co_{1/3}O₂ | 30 | PE |
| A41 | LiCo_{0.995}Mg_{0.003}Al_{0.002}O₂ | 70 | LiNi_{1/3}Mn_{1/3}Co_{1/3}O₂ | 30 | PE |
| A42 | LiCo_{0.9}Mg_{0.095}Al_{0.005}O₂ | 70 | LiNi_{1/3}Mn_{1/3}Co_{1/3}O₂ | 30 | PE |
| A43 | LiCoO₂ | 70 | LiNi_{0.27}Mn_{0.3}Co_{0.43}O₂ | 30 | PE |
| A44 | LiCoO₂ | 70 | LiNi_{0.5}Mn_{0.2}Co_{0.3}O₂ | 30 | PE |
| B1 | LiCoO₂ | 100 | — | — | PE |
| B2 | LiCo_{0.975}Mg_{0.02}Al_{0.005}O₂ | 100 | — | — | PE |
| B3 | LiCo_{0.995}Mg_{0.003}Al_{0.002}O₂ | 100 | — | — | PE |
| B4 | LiCo_{0.9}Mg_{0.095}Al_{0.005}O₂ | 100 | — | — | PE |
| B5 | — | — | LiNi_{1/3}Mn_{1/3}Co_{1/3}O₂ | 100 | PE |
| B6 | LiCoO₂ | 70 | LiNi_{0.5}Mn_{0.5}O₂ | 30 | PE |
| B7 | LiCoO₂ | 70 | LiNi_{0.45}Mn_{0.45}Co_{0.1}O₂ | 30 | PE |
| B8 | LiCoO₂ | 70 | LiNi_{0.24}Mn_{0.3}Co_{0.46}O₂ | 30 | PE |
| B9 | LiCoO₂ | 70 | LiNi_{0.55}Mn_{0.2}Co_{0.25}O₂ | 30 | PE |

TABLE 3

| | | | | Specific surface | |
|---|---|---|---|---|---|
| | Mean particle | Mean particle | Density of | area of positive | Tap density of |
| | size of active | size of active | positive electrode | electrode active | positive electrode |
| | material A or C | material B | active material | material | active material |
| Battery | (μm) | (μm) | (g/cm³) | (m²/g) | (g/cm³) |
| A1 | 6.8 | 7.1 | 3.50 | 0.69 | 2.32 |
| A2 | 6.9 | 7.1 | 3.50 | 0.69 | 2.30 |
| A3 | 6.8 | 7.1 | 3.50 | 0.69 | 2.32 |
| A4 | 6.9 | 7.1 | 3.50 | 0.69 | 2.30 |
| A5 | 6.8 | 7.1 | 3.50 | 0.69 | 2.32 |
| A6 | 6.8 | 7.1 | 3.50 | 0.69 | 2.32 |
| A7 | 6.8 | 7.1 | 3.50 | 0.69 | 2.32 |
| A8 | 6.8 | 7.1 | 3.50 | 0.69 | 2.34 |
| A9 | 6.8 | 7.1 | 3.50 | 0.69 | 2.39 |
| A10 | 6.8 | 7.1 | 3.50 | 0.68 | 2.41 |
| A11 | 6.8 | 7.1 | 3.50 | 0.68 | 2.44 |
| A12 | 6.8 | 7.5 | 3.50 | 0.63 | 2.56 |
| A13 | 6.8 | 7.8 | 3.50 | 0.58 | 2.78 |
| A14 | 6.8 | 6.7 | 3.50 | 0.72 | 2.28 |
| A15 | 6.8 | 6.9 | 3.50 | 0.71 | 2.28 |
| A16 | 6.8 | 7.1 | 3.50 | 0.69 | 2.30 |
| A17 | 6.8 | 7.5 | 3.50 | 0.69 | 2.25 |
| A18 | 6.8 | 7.1 | 3.25 | 0.69 | 2.32 |
| A19 | 6.8 | 7.1 | 3.30 | 0.69 | 2.32 |
| A20 | 6.8 | 7.1 | 3.70 | 0.69 | 2.32 |
| A21 | 2.6 | 7.1 | 3.50 | 0.87 | 2.00 |
| A22 | 3.3 | 7.1 | 3.50 | 0.80 | 2.11 |
| A23 | 11.8 | 7.1 | 3.50 | 0.54 | 2.71 |
| A24 | 12.9 | 7.1 | 3.50 | 0.49 | 2.77 |

TABLE 4

| | | | | Specific surface | |
|---|---|---|---|---|---|
| | Mean particle | Mean particle | Density of | area of positive | Tap density of |
| | size of active | size of active | positive electrode | electrode active | positive electrode |
| | material A or C | material B | active material | material | active material |
| Battery | (μm) | (μm) | (g/cm³) | (m²/g) | (g/cm³) |
| A25 | 6.8 | 2.4 | 3.50 | 0.93 | 2.10 |
| A26 | 6.8 | 3.1 | 3.50 | 0.83 | 2.21 |
| A27 | 6.8 | 11.5 | 3.50 | 0.49 | 2.61 |
| A28 | 6.8 | 13.2 | 3.50 | 0.43 | 2.69 |
| A29 | 10.9 | 10.5 | 3.50 | 0.33 | 3.01 |
| A30 | 9.8 | 10.1 | 3.50 | 0.41 | 2.88 |
| A31 | 4.1 | 4.5 | 3.50 | 1.19 | 1.91 |
| A32 | 3.6 | 3.4 | 3.50 | 1.31 | 1.83 |
| A33 | 6.9 | 7.1 | 3.50 | 0.69 | 2.32 |
| A34 | 6.9 | 7.1 | 3.50 | 0.69 | 2.35 |
| A35 | 6.9 | 7.1 | 3.50 | 0.68 | 2.40 |
| A36 | 6.9 | 7.1 | 3.50 | 0.68 | 2.43 |
| A37 | 7.0 | 7.1 | 3.50 | 0.70 | 2.32 |
| A38 | 6.8 | 7.1 | 3.50 | 0.67 | 2.33 |
| A39 | 6.7 | 7.1 | 3.50 | 0.70 | 2.31 |
| A40 | 6.9 | 7.1 | 3.50 | 0.67 | 2.34 |
| A41 | 6.6 | 7.1 | 3.50 | 0.70 | 2.27 |
| A42 | 7.0 | 7.1 | 3.50 | 0.67 | 2.30 |
| A43 | 6.8 | 7.6 | 3.50 | 0.61 | 2.61 |
| A44 | 6.8 | 7.4 | 3.50 | 0.65 | 2.45 |
| B1 | 6.8 | — | 3.50 | 0.69 | 2.30 |
| B2 | 6.9 | — | 3.50 | 0.70 | 2.29 |
| B3 | 6.6 | — | 3.50 | 0.71 | 2.25 |
| B4 | 7.0 | — | 3.50 | 0.66 | 2.32 |
| B5 | — | 7.1 | 3.50 | 0.68 | 2.45 |
| B6 | 6.8 | 6.2 | 3.50 | 0.60 | 2.43 |
| B7 | 6.8 | 6.4 | 3.50 | 0.62 | 2.40 |
| B8 | 6.8 | 7.7 | 3.50 | 0.60 | 2.63 |
| B9 | 6.8 | 7.7 | 3.50 | 0.62 | 2.45 |

The high-temperature cycle characteristics and thermal stability of each of the batteries A1 to A44 and the comparative batteries B1 to B9 were evaluated as follows.

### [High-Temperature Cycle Characteristics]

Each battery was charged until the battery voltage reached 4.2 V in an atmosphere set at 45° C. at a current value of 1 It (A) (unit: ampere, I: current, t: time). Each battery after charging was discharged until the battery voltage was decreased to 3.0 V at a current value of 1 It(A). This charge/discharge was repeated 500 cycles. The capacity maintenance rate was defined as the ratio of the discharge capacity at the 500th cycle to the discharge capacity at the first cycle. The results obtained are shown in Tables 5 and 6. In Tables 5 and 6, the capacity maintenance rates are represented in terms of percentage.

### [Thermal Stability]

Each battery was charged at room temperature at a current value of 1 ItA until the battery voltage reached 4.25 V. Thereafter, each battery after charging was allowed to stand still in a thermostat bath, and was heated from room temperature at a temperature increase rate of 5° C./min until the temperature reached 150° C.

After heating, each battery was allowed to stand in an atmosphere set at 150° C. for 3 hours, and the highest attained temperature of the surface of each battery was measured. The smaller the heat generated by a battery, the closer the highest attained temperature of the battery surface is to 150° C. In other words, the thermal stability of the battery is high. It is to be noted that the end-of-charge voltage is usually 4.2 V when a battery is used in electronic devices or the like, but the end-of-charge voltage is varied depending on batteries. Thus, in this evaluation, the end-of-charge voltage was set at 4.25 V in consideration of the voltage variation.

The results thus obtained are shown in Tables 5 and 6.

TABLE 5

| | Capacity maintenance | Highest attained |
|---|---|---|
| Battery | rate (%) | temperature (° C.) |
| A1 | 94 | 155 |
| A2 | 95 | 154 |
| A3 | 92 | 151 |
| A4 | 94 | 150 |
| A5 | 94 | 151 |
| A6 | 93 | 151 |
| A7 | 92 | 150 |
| A8 | 85 | 159 |
| A9 | 87 | 154 |
| A10 | 83 | 153 |
| A11 | 79 | 152 |
| A12 | 79 | 155 |
| A13 | 82 | 153 |
| A14 | 89 | 154 |
| A15 | 76 | 155 |
| A16 | 85 | 157 |
| A17 | 83 | 158 |
| A18 | 73 | 156 |
| A19 | 81 | 157 |
| A20 | 88 | 159 |
| A21 | 93 | 167 |
| A22 | 90 | 159 |
| A23 | 82 | 152 |
| A24 | 73 | 151 |

TABLE 6

| | Capacity maintenance | Highest attained |
|---|---|---|
| Battery | rate (%) | temperature (° C.) |
| A25 | 91 | 164 |
| A26 | 90 | 158 |
| A27 | 85 | 154 |
| A28 | 77 | 153 |
| A29 | 73 | 154 |
| A30 | 82 | 155 |
| A31 | 92 | 159 |
| A32 | 94 | 163 |
| A33 | 86 | 158 |
| A34 | 89 | 153 |
| A35 | 84 | 152 |
| A36 | 79 | 151 |
| A37 | 95 | 154 |
| A38 | 93 | 156 |
| A39 | 94 | 158 |
| A40 | 93 | 159 |
| A41 | 94 | 155 |
| A42 | 92 | 153 |
| A43 | 83 | 154 |
| A44 | 82 | 155 |
| B1 | 68 | 173 |
| B2 | 70 | 167 |
| B3 | 69 | 168 |
| B4 | 68 | 165 |
| B5 | 51 | 153 |
| B6 | 46 | 165 |
| B7 | 42 | 155 |
| B8 | 68 | 155 |
| B9 | 68 | 156 |

As shown from the results in Tables 5 and 6, the batteries A1 to A44 are excellent in high-temperature cycle characteristics as compared to the comparative batteries B1 to B9. When the positive electrode active material comprises at least one of the active material A: LiₓCoO₂ and the active material C: LiₓCo_{1-y}M_{y}O₂, and the active material B: LiₓNi_{y}Mn_{z}M_{1-y-z}O₂ decreased is the amount of the transition metals, in the positive electrode active material, dissolved in the non-aqueous electrolyte in repeated charge/discharge cycles at 45° C. Conceivably, the degradation of the positive electrode active material was consequently suppressed.

The batteries A1 and A2 are lower in the highest attained temperature for heating at 150° C., and are shown to be improved in thermal stability, as compared to the comparative batteries B1 and B2. This is conceivably because by making the positive electrode active material comprise LiₓNi_{1/3}Mn_{1/3}Co_{1/3}O₂ (active material B) high in thermal stability, the thermal stability of the positive electrode active material is drastically improved as compared to the case where the active material A (LiₓCoO₂) or the active material C (LiₓCo_{1-y}M_{y}O₂) was used alone as the positive electrode active material.

As shown from a comparison between the results for the battery A1 and the results for the batteries A3 and A5 to A7, when the separator includes a heat-resistant resin, the thermal stability of the batteries can be further improved while the high-temperature cycle characteristics are maintained. Also from a comparison between the results for the battery A2 and the results for the battery A4, a similar tendency as described above was found.

Conceivably, the reasons why these results were obtained are that when the separator includes a heat-resistant resin, no contraction of the separator was caused at the time of heating at 150° C., and short-circuiting between the positive electrode and the negative electrode was able to be sufficiently suppressed.

As shown from the results for the batteries A1 and A8 to A11, the proportion of the active material B (LiNi_{1/3}Mn_{1/3}Co_{1/3}O₂) relative to the total amount of the active material A (LiCoO₂) and the active material B is preferably 10 to 90% by weight. In particular, when the proportion of the active material A relative to the total amount of the active material A and the active material B is 50 to 90% by weight, in other words, the proportion of the active material B relative to the total amount of the active material A and the active material B is 10 to 50% by weight, the thermal stability is high and excellent high-temperature cycle characteristics of 85% or more are obtained.

As shown from the results for the batteries A12 to A15, the proportion of Co relative to the total amount of the metal elements other than lithium set to be 20 to 50 mole % enabled to attain satisfactory capacity maintenance rates. It is to be noted that, when the proportion of Mn relative to the total amounts of the metal elements other than lithium was increased up to 40 mol % as in the battery A15, the high-temperature cycle characteristics were more degraded. This is conceivably because the increase of the amount of Mn contained in the active material B increased the elution amount of Mn to accelerate the degradation of the positive electrode active material in the high-temperature charge/discharge cycles.

On the other hand, when the proportion of Co relative to the total amount of metal elements other than lithium was set at 10 mole % or less as in the comparative batteries B6 and B7, the high-temperature cycle characteristics were found to be remarkably degraded as compared to the batteries A12 to A15. This is conceivably because when the amount of Co contained in the active material B was small, the crystallinity of the active material B was degraded and the high-temperature cycle characteristics were thereby degraded.

Accordingly, for the purpose of suppressing the elution of Mn from the active material B when repeating the charge/discharge cycle at high temperatures, the proportion of Co, in the active material B, relative to the total amount of the metal elements other than lithium is preferably set at 20 to 50 mole %.

As shown in the results for the batteries A16 and A17, even when the element M contained in the active material B was Mg or Al, satisfactory high-temperature cycle characteristics were obtained in the same manner as in the cases where Co was used as the element M. Additionally, even when the element M is a transition metal element other than those described above, satisfactory high-temperature cycle characteristics were obtained.

In the active material B, the proportion of Ni, the proportion of Mn and the proportion of the element M relative to the total amount of the metal elements other than lithium each are most preferably 1/3.

As shown from the results for the batteries A18 to A20, the density of the positive electrode active material in the positive electrode active material layer set at 3.3 to 3.7 g/cm³ enabled to obtain a capacity maintenance rate of 80% or more.

On the other hand, the density of the positive electrode active material set at 3.25 g/cm³ (battery A18) somewhat degraded the capacity maintenance rate so as to be 73%. The reasons for this are conceivably as follows. The small density of the positive electrode active material in the positive electrode active material layer enlarges the voids generated in the positive electrode active material layer, and consequently the non-aqueous electrolyte in the battery is much held in the voids. Consequently, the repeated charge/discharge cycles gradually decrease the amount of the non-aqueous electrolyte due to the side reactions with electrode surface and the like. Accordingly, after a large number of repeated charge/discharge cycles, no sufficient amount of non-aqueous electrolyte is present in the battery, so that the cycle characteristics are degraded.

It is to be noted that no battery in which the density of the positive electrode active material in the positive electrode active material layer was 3.75 g/cm³ was able to be produced. This is because when the positive electrode active material layer was subjected to press rolling, the positive electrode current collector was broken.

From the above-described results, the density of the positive electrode active material in the positive electrode active material layer is preferably 3.3 to 3.7 g/cm³.

As shown from the results for the batteries A21 and A25, when the mean particle size of the active material A was less than 3 μm (battery A21) and when the mean particle size of the active material B was less than 3 μm (battery A25), the highest attained temperature was 160° C. or higher when heated at 150° C., and the thermal stability of the battery tended to be somewhat degraded. This is conceivably because when the mean particle size was made small, the positive electrode plate and the non-aqueous electrolyte at high temperatures were made to react with each other more easily, and consequently the positive electrode active material became unstable. Accordingly, the mean particle size of each active material is preferably 3 μm or more.

On the other hand, as shown from the results for the batteries A24 and A28, when the mean particle size of the active material A was larger than 12 μm (battery A24) and when the mean particle size of the active material B was larger than 12 μm (battery A28), the capacity maintenance rate was somewhat degraded. This is conceivably because when the mean particle size of an active material became large, the specific surface area became small, so that the reaction area was decreased and the positive electrode and the negative electrode were rapidly degraded. Accordingly, the mean particle size of each active material is preferably 12 μm or less.

It is to be noted that what has been described above was also the case for the active material C.

From the above-described results, the mean particle size of each of the active material A, the active material B and the active material C is preferably 3 to 12 μm.

When the specific surface area and the tap density of the positive electrode active material were 0.4 m²/g or more and 2.9 g/cm³ or less, respectively (battery A30), the capacity maintenance rate was 82% and satisfactory high-temperature cycle characteristics were obtained. On the other hand, when the specific surface area and the tap density of the positive electrode active material were smaller than 0.4 m²/g and larger than 2.9 g/cm³, respectively (battery A29), the high-temperature cycle characteristics were somewhat degraded. This is conceivably because the decrease of the specific surface area of the positive electrode active material decreased the reaction area of the positive electrode and rapidly degraded the positive electrode and the negative electrode.

In each of the batteries A31 and A32, the capacity maintenance rate was 90% or more and excellent high-temperature cycle characteristics were obtained. On the other hand, when the specific surface area and the tap density of the positive electrode active material were larger than 1.2 m²/g and smaller than 1.9 g/cm³, respectively (battery A32), the highest attained temperature was 160° C. or higher when heated at 150° C., and the thermal stability tended to be somewhat degraded. This is conceivably because the increase of the reaction area of the positive electrode active material enhanced the reactivity of the positive electrode at high temperatures and consequently the heat generation amount in the battery was increased.

From the above-described results, the specific surface area and the tap density of the positive electrode active material are preferably 0.4 to 1.2 m²/g and 1.9 to 2.9 g/cm³, respectively.

As shown from the results for the batteries A2 and A33 to A36, the proportion of the active material B relative to the total amount of the active material B and the active material C is preferably 10 to 90% by weight. In particular, when the proportion of the active material C relative to the total amount of the active material B and the active material C is 50 to 90% by weight, in other words, when the proportion of the active material B relative to the total amount of the active material B and the active material C is 10 to 50% by weight, a high thermal stability is obtained and a capacity maintenance rate of 85% or more is obtained.

As shown from the results for the batteries A2 and A37 to A40, even when LiCo_{0.975}Mg_{0.025}O₂, LiCo_{0.975}Al_{0.025}O₂, LiCo_{0.975}Mg_{0.02}Zr_{0.005}O₂ or LiCo_{0.975}Mg_{0.02}Mo_{0.0005}O₂ was used in place of LiCo_{0.975}Mg_{0.02}Al_{0.005}O₂, a battery which had a high thermal stability and a capacity maintenance rate of 90% or more was obtained.

As shown from the results for the batteries A41 and A42 and the comparative batteries B3 and B4, when the proportion of the element M relative to the total amount of Co and the element M contained in the active material C was 0.5 to 10 mole %, the mixing of the active material C and the active material B improved the thermal stability and the high-temperature cycle characteristics as compared to the case where the active material C was used alone. Accordingly, in the active material C, the proportion of the element M relative to the total amount of Co and the element M is preferably 0.5 to 10 mole %.

The capacity maintenance rate of the battery A43 in which the ratio y/z of nickel to manganese in the active material B was 0.9 was as satisfactory as 83%. On the other hand, the capacity maintenance rate of the comparative battery B8 having a ratio y/z of 0.8 was 68%, i.e., a value lower than 70%. When the ratio y/z is smaller than 0.9 in the active material B, the manganese content relatively exceeds the nickel content. In this case, when the charge/discharge of the battery was repeated in a high-temperature environment, the dissolution amount of the transition metals such as manganese contained in the active material B into the non-aqueous electrolyte was increased, and consequently the positive electrode active material was degraded. Conceivably, the comparative battery B8 consequently underwent the degradation of the capacity maintenance rate.

The capacity maintenance rate of the battery A44 having a ratio y/z of 2.5 exhibited a value as high as 82%. On the other hand, the capacity maintenance rate of the battery A9 having a ratio y/z of 2.75 was 68%, i.e., lower than 70%. When the ratio y/z exceeds 2.5 in the active material B, the conductivity of the active material B is degraded. The conductivity degradation is increased with increasing repetition number of the charge/discharge cycle at high temperatures. Conceivably because of this, the comparative battery B9 underwent a remarkable degradation of the capacity maintenance rate.

As described above, when the positive electrode active material comprises at least one selected from the group consisting of the active material A and the active material C, and the active material B, there can be provided a battery superior in thermal stability and in high-temperature cycle characteristics compared with the case where the active material A, B or C is used alone.

It is to be noted that when the proportion of Ni in the active material B relative to the total amount of the metal element other than lithium was set at 10 to 50 mole %, and when the proportion of Mn in the active material B relative to the total amount of the metal element other than lithium was set at 20 to 50 mole %, the same effects as described above were obtained.

In above-described Examples, description has been made on the cases where the molar ratio “x” of lithium contained in each of the active material A, the active material B and the active material C was set at 1.0. In any of these active materials, as long as the molar ratio “x” of lithium was set at 0.9 to 1.2, similar effects as described above were obtained.

In above-described Examples, as the active material B, LiₓNi_{y}Mn Co_{1-y-z}O₂, LiₓNi_{y}Mn_{z}Mg_{1-y-z}O₂ and LiₓNi_{y}Mn_{z}Al_{1-y-z}O₂ were used. Also, in the cases where LiₓNi_{y}Mn_{z}Ti_{1-y-z}O₂, LiₓNi_{y}Mn_{z}Sr_{1-y-z}O₂, LiₓNi_{y}Mn_{z}Ca_{1-y-z}O₂, LiₓNi_{y}Mn_{z}V_{1-y-z}O₂, LiₓNi_{y}Mn_{z}Fe_{1-y-z}O₂, LiₓNi_{y}Mn_{z}Y_{1-y-z}O₂, LiₓNi_{y}Mn_{z}Zr_{1-y-z}O₂, LiₓNi_{y}Mn_{z}Mo_{1-y-z}O₂, LiₓNi_{y}Mn_{z}Tc_{1-y-z}O₂, LiₓNi_{y}Mn_{z}Ru_{1-y-z}O₂, LiₓNi_{y}Mn_{z}Ta_{1-y-z}O₂, LiₓNi_{y}Mn_{z}W_{1-y-z}O₂ or LiₓNi_{y}Mn_{z}Re_{1-y-z}O₂ was used as the active material B, similar effects as described above were obtained.

Additionally, in above-described Examples, as the active material C, LiₓCo_{1-y}(MgAl)_{y}O₂, LiₓCo_{1-y}Mg_{y}O₂, LiₓCo_{1-y}Al_{y}O₂, LiₓCo_{1-y}(MgZr)_{y}O₂ and LiₓCo_{1-y}(MgMo)_{y}O₂ were used. Also in the cases where as the element M contained in LiₓCo_{1-y}M_{y}O₂, at least one selected from the group consisting of Sr, Mn, Ni, Ca, V, Fe, Y, Zr, Mo, Tc, Ru, Ta, W, Re, Yb, Cu, Zn and Ba was used, similar effects as described above were obtained.

Further, in above-described Examples, rectangular non-aqueous electrolyte secondary batteries were produced. Even when the shape of the battery is a cylindrical shape, a coin shape, a button shape, a laminate shape or the like, similar effects as described above are obtained.

### INDUSTRIAL APPLICABILITY

The non-aqueous electrolyte secondary battery of the present invention is excellent in thermal stability and high-temperature cycle characteristics. Accordingly, the non-aqueous electrolyte secondary battery of the present invention can be used, for example, as the main power source for use in mobile tools for consumers such as cellular phones and notebook-size personal computers, as the main power source for use in power tools such as electric screwdrivers, and the main power source for use in EV automobiles.

1. A non-aqueous electrolyte secondary battery that comprises: a positive electrode comprising a positive electrode active material layer including a positive electrode active material; a negative electrode comprising a negative electrode active material layer including a negative electrode active material capable of absorbing and desorbing lithium; a non-aqueous electrolyte; and a separator, wherein
the positive electrode active material comprises at least one selected from the group consisting of an active material A and an active material C, and an active material B;
the active material A is a first lithium composite oxide represented by the formula (1):
LiₓCoO₂ (1)
where 0.9≦x≦1.2;
the active material B is a second lithium composite oxide represented by the formula (2):
LiₓNi_{y}Mn_{z}M_{1-y-z}O₂ (2)
where 0.9≦x≦1.2, 0.1≦y≦0.5, 0.2≦z≦0.5, 0.2≦1−y−z≦0.5 and 0.9≦y/z≦2.5; and M is at least one selected from the group consisting of Co, Mg, Al, Ti, Sr, Ca, V, Fe, Y, Zr, Mo, Tc, Ru, Ta, W and Re; and
the active material C is a third lithium composite oxide represented by the formula (3):
LiₓCo₁₋ₐMₐO₂ (3)
where 0.9≦x≦1.2 and 0.005≦a≦0.1; and M is at least one selected from the group consisting of Mg, Al, Ti, Sr, Mn, Ni, Ca, V, Fe, Y, Zr, Mo, Tc, Ru, Ta, W, Re, Yb, Cu, Zn and Ba.

2. The non-aqueous electrolyte secondary battery according to claim 1, wherein the separator comprises a porous film including a heat-resistant resin, and the heat-resistant resin contains chlorine atoms.

3. The non-aqueous electrolyte secondary battery according to claim 2, wherein the separator further comprises a porous film including polyolefin.

4. The non-aqueous electrolyte secondary battery according to claim 2, wherein the porous film including the heat-resistant resin includes a filler.

5. The non-aqueous electrolyte secondary battery according to claim 2, wherein the heat-resistant resin includes at least one selected from the group consisting of aramid and polyamideimide.

6. The non-aqueous electrolyte secondary battery according to claim 1, wherein the active material B accounts for 10 to 90% by weight of the positive electrode active material.

7. The non-aqueous electrolyte secondary battery according to claim 1, wherein the active material B accounts for 10 to 50% by weight of the positive electrode active material.

8. The non-aqueous electrolyte secondary battery according to claim 1, wherein the element M contained in the active material B is Co.

9. The non-aqueous electrolyte secondary battery according to claim 1, wherein in the active material B, the molar ratio “y” of Ni and the molar ratio “z” of Mn to the total amount of Ni, Mn and the element M are both 1/3.

10. The non-aqueous electrolyte secondary battery according to claim 1, wherein the density of the positive electrode active material in the positive electrode active material layer is 3.3 to 3.7 g/cm³.

11. The non-aqueous electrolyte secondary battery according to claim 1, wherein the mean particle size of the active material A or the active material C is 3 to 12 μm.

12. The non-aqueous electrolyte secondary battery according to claim 1, wherein the mean particle size of the active material B is 3 to 12 μm.

13. The non-aqueous electrolyte secondary battery according to claim 1, wherein the specific surface area of the positive electrode active material is 0.4 to 1.2 m²/g.

14. The non-aqueous electrolyte secondary battery according to claim 1, wherein the tap density of the positive electrode active material is 1.9 to 2.9 g/cm³.
